(19) United States
(12) Patent Application Publication
(10) Pub. No.: US 2026/0290375 A1
(43) Pub. Date: Sep. 24, 2026

(54) SYSTEM

(71) Applicant: SoftBank Group Corp., Tokyo (JP)

(72) Inventor: Shizuka GOTO, Tokyo (JP)

(73) Assignee: SoftBank Group Corp., Tokyo (JP)

(21) Appl. No.: 19/558,626

(22) Filed: Mar. 6, 2026

(30) Foreign Application Priority Data
Mar. 19, 2025 (JP) 2025-044505

(51) Int. Cl. G10L 25/63; G06N 3/0475

(52) U.S. Cl. CPC G10L 25/63; G06N 3/0475

(57) ABSTRACT

A system includes a processor that is configured to obtain dialog data from a communication application, generate a prompt sentence based on the obtained dialog data, input the generated prompt sentence into a generative artificial intelligence model to predict one or more characteristics or impressions, generate visual information based on the predicted one or more characteristics or impressions, and present the generated visual information to a terminal of a user.

### CROSS-REFERENCE TO RELATED APPLICATION

This application is based on and claims priority under 35 USC 119 from Japanese Patent Application No. 2025-044505 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that analyze user communication primarily focus on textual analysis or simple sentiment classification and do not provide an effective way to convert predicted user characteristics or impressions into intuitive visual representations. In many cases, dialog data obtained from communication applications is either not utilized at all, or is used only for basic analytics, thereby failing to offer users a rich, personalized, and easily understandable feedback experience. Furthermore, existing approaches do not systematically generate prompt sentences from dialog data and do not effectively utilize generative artificial intelligence models together with external information sources to refine prediction of characteristics or impressions. As a result, there is a need for a system that can: (i) automatically obtain dialog data from a communication application, (ii) generate appropriate prompts from that dialog data, (iii) predict user characteristics or impressions using a generative artificial intelligence model, and (iv) generate and present visual information that expresses such characteristics or impressions, preferably in real time and in a form suitable for display on a user terminal.

### SUMMARY

In order to solve the above-described problems, the present invention provides a system comprising a processor, wherein the processor is configured to obtain dialog data from a communication application, generate a prompt sentence based on the obtained dialog data, input the generated prompt sentence into a generative artificial intelligence model to predict one or more characteristics or impressions, generate visual information based on the predicted one or more characteristics or impressions, and present the generated visual information to a terminal of a user. The processor may be further configured to use the prompt sentence to obtain required data from an external information source and apply a learning algorithm to predict and generate the one or more characteristics or impressions, thereby enhancing accuracy and richness of the prediction. In addition, the processor may be configured to use a graphics rendering engine to display the generated visual information on a display in real time, enabling the user to immediately view a visual representation of the predicted characteristics or impressions on the user terminal.

The term “system” refers to a combination of hardware and software components, including at least one processor and associated memory and interfaces, that cooperatively perform the functions specified in the claims.

The term “processor” refers to one or more hardware processing units, such as a central processing unit (CPU), graphics processing unit (GPU), digital signal processor (DSP), or other computation circuitry, configured to execute instructions to perform the claimed operations.

The term “communication application” refers to any software application or service that enables exchange of messages or dialog between users, including but not limited to messenger applications, chat applications, social networking applications, or email clients.

The term “dialog data” refers to data representing one or more exchanges of communication between users, including at least message content and optionally metadata such as timestamps, sender identifiers, or conversation context.

The term “prompt sentence” refers to a text string or structured textual input generated from the dialog data and used as an input query or instruction for a generative artificial intelligence model or other learning algorithm.

The term “generative artificial intelligence model” refers to a machine learning model configured to generate outputs, such as text or feature representations, in response to input data, and capable of predicting or inferring characteristics or impressions based on the prompt sentence.

The term “characteristics or impressions” refers to inferred properties, traits, attitudes, moods, personalities, or perceived attributes of a user, as predicted from dialog data, including but not limited to optimistic, pessimistic, active, passive, or similar descriptors.

The term “visual information” refers to data defining one or more visual elements, such as images, graphics, animations, or visual effects, that represent the predicted characteristics or impressions in a form suitable for display on a screen.

The term “terminal” refers to an electronic device operated by a user, such as a smartphone, tablet, personal computer, wearable device, or other client device, that is capable of running a communication application and displaying visual information.

The term “external information source” refers to any data source located outside the system's primary dialog data storage, including but not limited to web services, databases, knowledge bases, or third-party APIs, from which additional data can be obtained using the prompt sentence.

The term “learning algorithm” refers to a computational procedure, including but not limited to supervised, unsupervised, or reinforcement learning methods, that processes input data and adjusts model parameters or computes outputs in order to predict or generate characteristics or impressions.

The term “graphics rendering engine” refers to software and/or hardware components configured to convert visual information into pixel data for display, including real-time rendering engines, 2D or 3D graphics libraries, and associated drivers.

The term “display” refers to an output device or screen associated with the terminal or another device, such as an LCD, OLED, or other visual display unit, on which the generated visual information is presented in visible form.

The term “real time” refers to processing and display of the generated visual information with a latency that is sufficiently short that a user perceives the visual information as being updated substantially immediately in response to the underlying prediction or generation processing.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

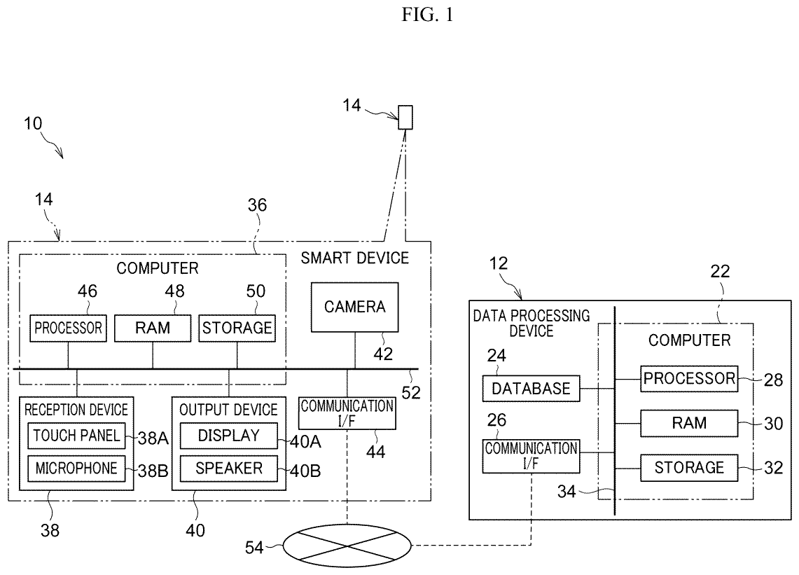

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

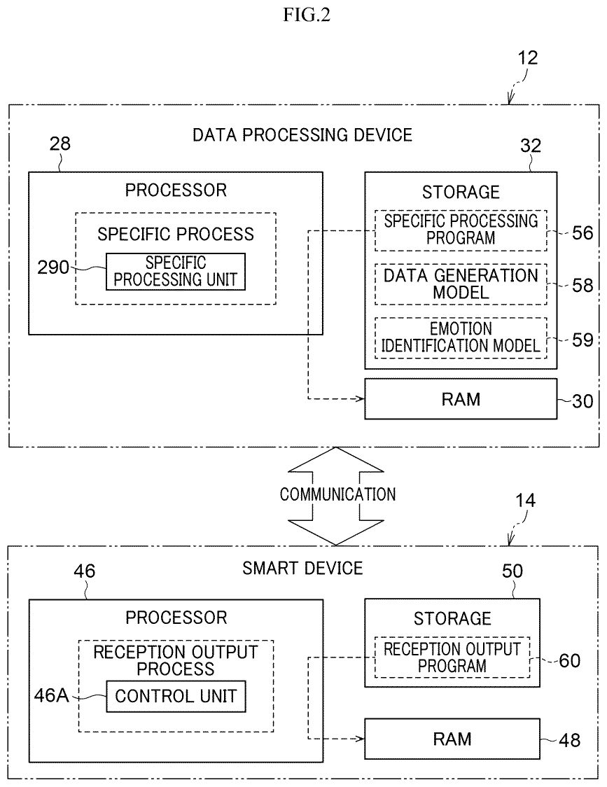

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In contemporary networked environments, communication applications executed on user terminals generate large volumes of dialog data in the form of text messages and related metadata. Conventional systems that attempt to analyze such dialog data and present results to users suffer from several technical shortcomings at the computing-system level.

First, conventional systems generally treat dialog data as unstructured text and apply generic analysis routines or fixed rules without systematically transforming the dialog data into a prompt sentence suited for interaction with a generative AI model. As a result, the dialog data is not efficiently organized for machine processing, and the computing resources of the underlying processing hardware are used in a suboptimal manner, for example by repeatedly transmitting excessive or redundant text segments to external models, which increases processing latency, network bandwidth consumption, and memory usage.

Second, conventional architectures lack an integrated mechanism on the server side to consistently acquire dialog data from diverse communication applications, store the dialog data in a storage device together with associated information, aggregate the stored dialog data for a particular user, and construct a prompt sentence that is specifically tailored to elicit prediction information regarding characteristics and impressions of the user. In many existing solutions, the prompt construction is done manually or in an ad hoc fashion in client software, leading to fragmented processing flows, increased coupling between client and server, and difficulties in scaling the analysis across many users in a networked environment.

Third, even when a generative AI model is invoked, conventional systems do not provide an efficient technical framework for converting prediction results into numerical information or structured information in a form that is consistently consumable by visualization components. In the absence of such a framework, extensive post-processing is required on the client side, causing increased computation at the terminal, reduced responsiveness of user interfaces, and redundant data transformations across different application components.

Fourth, known systems fail to provide a unified server-side pipeline for generating visual information, such as graphs or figures representing personality dimensions, and for transmitting such visual information over a communication network to a terminal in a displayable format. As a result, rendering logic and data-format translation are frequently re-implemented on each client device, which increases the overall complexity of the system, leads to inconsistent rendering behavior across different devices, and complicates maintenance and upgrades.

Accordingly, there is a need for an improved computer-implemented technique that: (i) systematically acquires and stores dialog data with associated information, (ii) automatically aggregates the stored dialog data and generates an appropriate prompt sentence for a generative AI model, (iii) efficiently converts prediction information from the generative AI model into numerical or structured information, (iv) generates visual information that represents personality characteristics of a user based on the structured information, and (v) transmits and presents the visual information to a user terminal in a displayable format. By addressing these issues, the invention can improve the efficiency, scalability, and consistency of server-side processing for dialog-based personality analysis and visualization in communication systems.

The specific processing by the specific processing unit 290 of the data processing device 12 in Example 1 is realized by the following means.

The present invention provides a server comprising a processor and a storage device, the processor being configured to acquire dialog data from a communication application executed on a terminal operated by a user, store the acquired dialog data in the storage device together with associated information including at least a user identifier and time information, aggregate dialog data stored in the storage device for a particular user and generate a prompt sentence to be input to a generative AI model based on the aggregated dialog data, input the generated prompt sentence to the generative AI model and obtain prediction information relating to characteristics and impressions of the user corresponding to the dialog data, convert the obtained prediction information into numerical information or structured information and generate visual information representing personality characteristics of the user on the basis of the numerical information or the structured information, and transmit the generated visual information via a communication network in response to a request from the terminal or in accordance with a predetermined condition and present the visual information in a displayable format on the terminal. This enables a unified and computer-efficient server-side processing pipeline that transforms raw dialog data into structured prediction information and visual information using a generative AI model, thereby reducing redundant client-side processing, improving utilization of computing and network resources, and providing consistent and scalable generation and presentation of personality-related visualizations across multiple terminals.

The term “processor” refers to a hardware computing element or a combination of hardware computing elements that execute machine-readable instructions to perform data acquisition, data processing, and control operations within the system.

The term “storage device” refers to a hardware memory component or a combination of hardware memory components, including volatile or non-volatile memory, that store dialog data, associated information, prediction information, and visual information used by the processor.

The term “dialog data” refers to electronic data representing at least text-based exchanges between one or more users via a communication application, including messages sent and received, and optionally metadata associated with such messages.

The term “communication application” refers to a software program or service that enables users to exchange information in real time or near real time via a network, using at least text messages, and that is executable on a terminal.

The term “terminal” refers to an electronic apparatus, such as a computing device operated by a user, that executes a communication application, exchanges dialog data with a server via a network, and presents visual information to the user.

The term “associated information” refers to metadata stored together with dialog data, including at least a user identifier and time information, and optionally additional information such as conversation identifiers, device identifiers, or application identifiers.

The term “user identifier” refers to information that uniquely or pseudo-uniquely identifies a user within the system or within a communication application, such as an alphanumeric code, account identifier, or other distinguishing label.

The term “time information” refers to data indicating a temporal attribute of dialog data, such as a timestamp, date, time of day, or time range associated with the creation, transmission, or reception of a message.

The term “aggregate” refers to processing that combines, selects, orders, or groups multiple items of dialog data associated with a particular user into a form suitable for further analysis or for inclusion in a prompt sentence.

The term “prompt sentence” refers to a machine-readable input string or text sequence constructed by the processor, at least in part from dialog data, that is designed to instruct and provide context to a generative AI model so as to obtain prediction information.

The term “generative AI model” refers to a machine learning model, such as a neural network trained on large-scale data, that generates output data, including natural language text, in response to an input such as a prompt sentence.

The term “prediction information” refers to information generated by the generative AI model in response to a prompt sentence, the information including at least inferred characteristics and impressions of a user derived from dialog data.

The term “characteristics and impressions” refers to inferred attributes of a user, including at least personality traits, behavioral tendencies, emotional tendencies, and perceived attitudes derived from analysis of dialog data.

The term “numerical information” refers to data represented in numeric form, such as scores, ratings, or indices, that quantify aspects of the prediction information, including but not limited to personality dimensions or emotional intensities.

The term “structured information” refers to prediction information arranged in a predefined data format, such as a key-value structure, list, table, or hierarchical representation, that allows systematic processing by software components.

The term “visual information” refers to data defining one or more visual representations, including graphs, charts, figures, icons, or composite images, that express personality characteristics or related prediction information in a human-perceivable graphical form.

The term “personality characteristics” refers to aspects of a user's personality, such as dimensions, traits, or profiles, that are inferred from dialog data and expressed in numerical, structured, or visual forms.

The term “communication network” refers to an infrastructure, including wired or wireless links and intermediate nodes, that enables data exchange between a server and one or more terminals.

The term “displayable format” refers to a data format that can be rendered as a visual output on a display device of a terminal, including but not limited to image data, graphical configuration data, and formatted text data.

The term “request from the terminal” refers to a communication initiated by the terminal, such as an API call or message, that instructs the server to perform an operation including transmission of visual information.

The term “predetermined condition” refers to a condition defined in advance by configuration, rules, or program logic, such as a time-based trigger, completion of data acquisition, or threshold of available dialog data, under which the processor initiates transmission of visual information without requiring an explicit request from the terminal.

The term “graph information” refers to data that defines parameters of a graphical representation, such as axes, labels, values, colors, and layout, for rendering charts, plots, or diagrams representing prediction information.

The term “figure information” refers to data that defines parameters of a non-chart graphical representation, such as shapes, icons, avatars, or composite illustrations, for visually expressing prediction information.

The term “display control information” refers to data generated by the processor that specifies how visual information, graph information, or figure information is to be rendered on a terminal, including layout, style, and interaction parameters.

The term “plurality of personality dimensions” refers to two or more distinct axes or categories used to characterize aspects of a user's personality, such as different trait scales or behavioral factors.

In one embodiment, a server, a terminal, and a communication network cooperate to implement the claimed system. The server includes at least one processor, a main memory, and a non-volatile storage device, and operates under control of an operating system such as a general-purpose server operating system. The terminal includes at least one processor, a memory, a display device, and a network interface, and executes a communication application that exchanges dialog data with the server over the communication network.

The terminal executes a communication application that provides a user interface for sending and receiving text messages. The terminal acquires dialog data generated by the user and one or more other participants by accessing an application programming interface of the communication application. The terminal transmits the acquired dialog data, together with associated information such as a user identifier and time information, to the server via the communication network using a network protocol such as HTTP over TCP/IP.

The server receives the dialog data and associated information through a network interface and stores the data in a storage device such as a relational database management system. The server uses a database engine such as a generic relational database engine to maintain tables that include fields for a user identifier, a message text, time information, and optional conversation identifiers. The server writes each received message as a record into a messages table and associates the record with a user record in a users table. The server thereby creates a structured corpus of dialog data that is indexed by user identifiers and timestamps. This structured storage improves data retrieval performance compared with unindexed text logs and reduces memory usage by separating metadata from message content.

The server retrieves dialog data from the storage device for a particular user by executing queries that select messages within a specified time range or of a specified length. The server uses the time information to order the dialog data chronologically and applies filtering rules to remove low-information items such as single-character messages or control messages. The server aggregates the remaining dialog data into an intermediate representation in memory, for example, as an ordered list of message objects. The server then constructs a prompt sentence based on this intermediate representation.

The server generates the prompt sentence by inserting at least a part of the dialog data into a predetermined template. The server selects messages according to token-length constraints of a generative AI model and includes analytical instructions that specify the type of prediction information to be produced. For example, the server constructs a prompt sentence such as:

You are an expert psychologist AI.

Analyze the user's personality and impressions from the following conversation logs.

### Conversation Logs

I often plan everything in detail, because I don't like unexpected changes.

Recently I felt stressed when my schedule changed suddenly.

I enjoy learning new skills, but I worry a lot about failing.

### Task

1. Describe the user's main personality traits.
2. Describe the user's emotional tendencies.
3. Describe how the user tends to communicate with others.

Output in concise English.

In another example, the server constructs a prompt sentence as:

Please analyze the user's personality based on the following conversation.

### Conversation Logs

I like to plan everything in detail, and I am not good at dealing with sudden changes to my schedule.

Recently, I felt a great deal of stress when my schedule was changed unexpectedly.

I enjoy trying new things, but I worry a lot about failing.

In a further example, the server constructs a prompt sentence that explicitly instructs numerical scoring:

You are a generative AI model specialized in personality analysis.

Use the following conversation logs to infer the user's personality.

### Conversation Logs

[CONVERSATION_TEXT]

Please respond in the following structure:
summary: brief summary of the user's personality
emotional_tendencies: description of typical emotions and reactions
big_five: scores from 1 to 5 for openness, conscientiousness, extraversion, agreeableness, neuroticism
communication_style: short description

The server determines the template and the amount of dialog data to insert according to pre-defined rules that consider maximum allowed input length, semantic diversity, and distribution of time information. This non-trivial prompt construction differs from a simple concatenation of messages because the server uses technical constraints of the generative AI model and data-structure considerations to optimize the quality and efficiency of analysis.

The server inputs the generated prompt sentence to a generative AI model. In one embodiment, the generative AI model is a transformer-based neural network implemented on an external computation environment and accessed by the server via an application programming interface. The server sends the prompt sentence as text input and specifies model parameters such as a model identifier, a temperature parameter, and a maximum output length. The generative AI model includes multiple self-attention layers that compute contextual representations of the prompt sentence tokens, uses positional encodings, and applies a feedforward network to produce output token distributions. The generative AI model has been trained on large-scale text data using supervised learning and unsupervised pretraining with an objective function that minimizes prediction error of subsequent tokens. During training, the generative AI model adjusts its weight parameters via gradient-based optimization, such as stochastic gradient descent or its variants, and applies regularization techniques to prevent overfitting.

The server uses this specific neural architecture to exploit contextual semantics of the dialog data and the instructions in the prompt sentence. The server benefits from attention mechanisms that focus computational resources on key parts of the dialog data, such as expressions of preference or emotional reactions. This architecture enables the server to obtain high-precision prediction information about personality characteristics from long and noisy dialog histories, beyond the capabilities of simple keyword-based or rule-based engines.

The server receives prediction information from the generative AI model in the form of generated text. The server parses the output based on the structure requested in the prompt sentence. For example, the server detects sections corresponding to summary, emotional tendencies, and personality dimensions. The server then converts the natural-language output into numerical information or structured information. For numerical information, the server applies parsing rules to extract numeric scores from text and assigns them to specific personality dimensions. For structured information, the server maps textual labels to fields in an internal data object, such as trait names and descriptions. The server optionally normalizes scores across different analyses to a common scale.

The server stores the prediction information, including the structured representation of characteristics and impressions, in the storage device. The server associates this information with the corresponding user identifier and time information. By structuring prediction information in this way, the server can efficiently retrieve and compare multiple analyses for the same user over time. The server thereby improves data organization and reduces the need for repeated full reanalysis of historical dialog data.

The server generates visual information based on the numerical information or structured information. The server uses a graphical generation module that converts personality dimension scores and categorical labels into parameters for graphical representations. For example, the server computes coordinates and radii for a radar chart representing multiple personality dimensions. The server defines color assignments, line thickness, and axis labels as part of graph information. The server may also define figure information for avatar-style visualizations that encode personality profiles by selecting shapes, color palettes, and layout based on trait scores. The server thus creates visual information that is directly renderable by a terminal.

The server generates display control information that specifies how the terminal is to render the visual information. The server defines layout regions, font sizes, and interaction hints (such as which areas can be tapped or clicked) and packages this information together with graph information or figure information. The server sends the visual information and the display control information to the terminal via the communication network when the terminal requests a report or when a predetermined condition is satisfied, such as the completion of a new analysis cycle.

The terminal receives the visual information and the display control information and renders a display image on a display device. The terminal uses a rendering engine, such as a browser engine or a graphical user interface toolkit, to draw charts and figures according to the parameters provided by the server. The terminal then presents a graphical representation of personality characteristics, for example a radar plot with labeled axes for different personality dimensions and textual summary information.

The user views the rendered visual information on the terminal. The user can understand personality tendencies through the graphical representation without manually reading and interpreting raw dialog logs or long textual reports. The system therefore reduces cognitive load on the user and improves the usability of personality analysis in communication environments.

In another embodiment, the server executes an alternative generative AI model deployed on-premises. The server loads the generative AI model weights into memory and performs inference locally, using the processor and, optionally, a hardware accelerator such as a general-purpose graphics processing unit. The server applies the same prompt sentence generation strategy and structured output parsing, but without relying on an external network service. This embodiment reduces the communication load with external providers and improves latency and data privacy.

In yet another embodiment, the server employs different templates for the prompt sentence depending on application requirements. For example, the server may generate a prompt sentence that emphasizes emotional tendencies and omits detailed personality dimensions, or a prompt sentence that requests classification into predefined personality categories. The server selects the template according to configuration data or according to the type of terminal requesting the analysis. This flexibility enables the system to support different visualization modes while maintaining a common internal pipeline for dialog data aggregation and prediction information processing.

The server improves computer technology in several ways. First, the server reduces the amount of data transmitted to the generative AI model by aggregating and selecting dialog data under token-length constraints. This leads to lower network traffic and faster model-inference times compared with naive submission of entire conversation histories. Second, the server structures prediction information as numerical information and structured information immediately upon receipt, which avoids repeated text parsing on multiple clients and allows centralized optimization of parsing algorithms. Third, the server offloads complex chart parameter computation and layout calculation from terminals to the server, allowing terminals with limited processing power to display advanced visualizations with low latency.

The server uses a non-conventional combination of data structures and processing stages that is different from a mere automation of human interpretation. A human analyst would typically read full conversations sequentially and produce narrative summaries, whereas the server applies machine-oriented operations such as token-length-based selection, template-based encoding into prompt sentences, transformer-based attention computations, and structured mapping into fixed personality dimensions and graphical parameters. These operations involve algorithmic transformations that are tailored to the capacities and constraints of a generative AI model and to the rendering capabilities of terminals.

The server additionally implements error-handling and stability-enhancing procedures. For example, the server detects incomplete or malformed outputs from the generative AI model and applies fallback strategies such as reissuing the prompt sentence with stricter formatting instructions or applying auxiliary rule-based checks. The server thereby increases robustness of the overall system and ensures that visual information can be generated even in the presence of irregular model outputs.

In still another embodiment, the server employs continuous updating of personality visualizations. The server periodically retrieves newly stored dialog data, regenerates a prompt sentence that incorporates recent messages, performs inference using the generative AI model, and updates numerical information for personality dimensions. The server then computes deltas between previous and current scores and modifies graph information accordingly, for example by highlighting changes or displaying trend arrows. This dynamic update process leverages the structured storage and standardized visualization pipeline to provide near real-time feedback without requiring complete recomputation of all past analyses.

The described embodiments focus on technical aspects of data acquisition, storage, structured transformation, neural-network-based inference, and visualization parameter generation. The server, the terminal, and the communication network cooperate to implement a specific computer-centered pipeline that improves processing efficiency, data organization, and usability of personality-related visualizations, thereby providing a concrete application of a generative AI model and a prompt sentence within a technical environment rather than as an abstract idea.

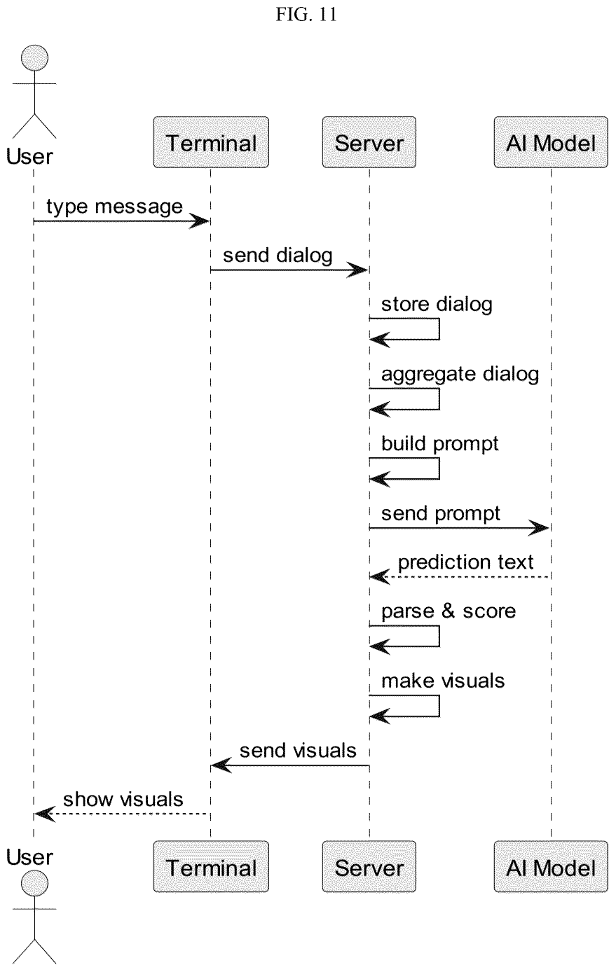

The following describes the processing flow using FIG. 11.

### Step 1

The user operates the terminal to execute a communication application and to generate dialog data.

The user inputs text messages through an input interface on the terminal, and the communication application displays both sent and received messages on the terminal's screen.

The input of this step is user-generated natural language text and responses from other participants, and the output is a sequence of dialog messages maintained by the communication application as message objects including text content and timing information.

### Step 2

The terminal acquires dialog data from the communication application through an application programming interface.

The terminal sends an API request to the communication application to obtain recent messages, receives the messages as structured data, and parses fields such as user identifiers, message texts, and timestamps.

The input of this step is the internal message store of the communication application, and the output is a list of parsed dialog entries each containing at least a user identifier, a message text string, and a timestamp value.

The terminal performs data extraction and parsing operations by reading JSON or similar formatted data and converting it into an internal data structure.

### Step 3

The terminal transmits the parsed dialog data and associated information to the server over a communication network.

The terminal packages the dialog entries into a request body, attaches authentication information, and sends the request to a server endpoint using a network protocol.

The input of this step is the list of parsed dialog entries on the terminal, and the output is a network message containing the dialog data delivered to the server.

The terminal performs data serialization and network transmission operations to encode the dialog data into a transferable format and to forward it to the server.

### Step 4

The server receives the network message and validates and normalizes the dialog data.

The server authenticates the request, parses the received structured data, verifies required fields, and normalizes message texts by removing invalid characters and harmonizing encoding formats.

The input of this step is the network message containing dialog data and associated information, and the output is a validated and normalized collection of dialog records stored in server memory for further processing.

The server performs data validation and normalization operations to ensure that subsequent database and analysis processing can be executed without errors.

### Step 5

The server stores the validated dialog data and associated information in a storage device as structured records.

The server inserts each dialog record into a messages table, links each record to a corresponding user identifier, and records the associated time information and optional conversation identifiers.

The input of this step is the collection of validated dialog records in server memory, and the output is a set of persisted database records accessible through indexed queries.

The server performs relational data mapping and write operations to convert in-memory data structures into persistent table rows with defined fields and indexes.

### Step 6

The server retrieves aggregated dialog data for a particular user from the storage device according to analysis conditions.

The server executes database queries that select dialog records matching a user identifier and, optionally, time ranges or other filters, and then orders the results chronologically.

The input of this step is the stored messages and user information in the storage device, and the output is an ordered list of dialog messages associated with the target user.

The server performs data selection and sorting operations by applying query conditions and ordering criteria to the structured database records.

### Step 7

The server filters and formats the retrieved dialog data to prepare an intermediate representation for prompt construction.

The server removes low-information messages such as extremely short strings, trims whitespace, and concatenates relevant messages into a sequence while preserving time order.

The input of this step is the ordered list of dialog messages, and the output is a cleaned and consolidated text sequence and a corresponding list of message segments suitable for generating a prompt sentence.

The server performs text filtering and concatenation operations to transform multiple message records into a compact representation that retains important semantic content.

### Step 8

The server generates a prompt sentence for a generative AI model based on the intermediate representation and a predetermined template.

The server selects a template, inserts the cleaned dialog text into predefined placeholders, and appends explicit instructions describing the required prediction information such as personality traits and emotional tendencies.

The input of this step is the consolidated dialog text and template rules, and the output is a single prompt sentence string that encodes both dialog content and analysis instructions.

The server performs template expansion and string composition operations to produce a prompt sentence that conforms to length constraints and semantic requirements of the generative AI model.

### Step 9

The server transmits the prompt sentence to the generative AI model and requests prediction information.

The server encapsulates the prompt sentence into a request format supported by the generative AI model, sets inference parameters such as maximum output length, and sends the request to an inference endpoint.

The input of this step is the generated prompt sentence, and the output is a response message from the generative AI model that contains generated text describing predicted characteristics and impressions.

The server performs network invocation and parameter configuration operations to deliver the prompt sentence and to initiate neural network inference on the generative AI model.

### Step 10

The server parses the response text from the generative AI model and extracts structured prediction information.

The server identifies sections in the response corresponding to summary descriptions, emotional tendencies, and personality dimensions, and then maps these sections into structured fields and numerical scores according to parsing rules.

The input of this step is the raw text response from the generative AI model, and the output is structured prediction information including numerical values and labeled descriptions associated with specific personality dimensions.

The server performs text segmentation, pattern matching, and numeric extraction operations to convert unstructured generated text into a machine-usable representation.

### Step 11

The server stores the structured prediction information in the storage device and links it to the user.

The server writes the prediction summary, numerical scores, and categorical labels into a prediction table, associates each entry with the user identifier and analysis time, and optionally maintains references to the underlying dialog data.

The input of this step is the structured prediction information in server memory, and the output is a set of persistent prediction records accessible for later retrieval and visualization.

The server performs database insertion and association operations to preserve the analysis results in a form suitable for longitudinal comparison and reporting.

### Step 12

The server generates visual information representing personality characteristics based on the stored prediction information.

The server transforms numerical scores for personality dimensions into visual parameters such as axis values, polygon coordinates, color intensities, or bar heights and constructs data structures that describe graphs or figures.

The input of this step is the structured prediction information comprising numerical scores and labels, and the output is visual information including graph definitions, figure parameters, and layout attributes.

The server performs numeric-to-graphic mapping and layout calculation operations to convert abstract personality metrics into concrete visual configurations usable by a rendering engine.

### Step 13

The server prepares display control information and sends the visual information to the terminal through the communication network.

The server packages the visual parameters and layout instructions into a response message, selects an appropriate representation format, and transmits the response to the terminal in reaction to a request or based on a predetermined trigger condition.

The input of this step is the generated visual information and rendering rules, and the output is a network response message containing all data required for the terminal to render a display image.

The server performs response composition and network transmission operations to deliver visual content and display control metadata to the terminal.

### Step 14

The terminal receives the visual information and display control information and renders a graphical representation on a display device.

The terminal interprets the received graph and figure parameters, invokes a rendering subsystem to draw axes, shapes, and text labels, and composes a final image that presents the personality characteristics to the user.

The input of this step is the response message containing visual information and display control data, and the output is a rendered visual display on the terminal's screen.

The terminal performs parsing, graphical drawing, and user interface update operations to transform received data into a human-perceivable visualization.

### Step 15

The user views the rendered graphical representation and optionally initiates further interaction with the system.

The user observes the displayed graphs and summaries, interprets the visualized personality information, and may issue new commands via the terminal to request updated analyses or to change display options.

The input of this step is the rendered visual display on the terminal, and the output is new user actions and commands that can trigger additional processing cycles in the server and terminal.

The user performs interpretation and control operations that close the loop between dialog generation, computational analysis by the server and the generative AI model, and visualization on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems for human-to-human interaction, such as messaging platforms and customer service tools, primarily provide raw text or basic sentiment tags without generating structured, real-time guidance that can be directly consumed and acted upon at an endpoint device. In many existing architectures, conversational data is merely logged or subjected to static rule-based analysis, resulting in delayed, coarse, or context-insensitive feedback. As a consequence, endpoint devices, including portable terminals and wearable displays, cannot leverage the full computational capability of remote servers and advanced machine learning models to present immediate, context-aware visual guidance to a user engaged in an ongoing interaction.

Furthermore, in typical implementations of machine learning-based analysis, conversational input is processed as isolated utterances. Prompt construction for a generative AI model is often ad hoc and does not systematically encode time-series conversational context, prediction conditions, or output format constraints. This leads to inconsistent prediction quality, instability of outputs, and an inability of the overall system to reliably convert unstructured conversational streams into normalized, machine-usable feature values. Endpoint presentation modules are then forced to operate on loosely structured or ambiguous results, degrading the determinism, latency, and usability of the system as a whole.

In addition, conventional visualization pipelines for personality-or impression-related indicators frequently treat visualization as a separate, manually configured layer. Servers do not consistently convert predicted feature values into normalized quantitative indices and do not deterministically map those indices to visualization parameters such as hue, shape, and layout. As a result, the rendering logic on the endpoint device becomes complex, device-specific, and difficult to synchronize with upstream prediction logic, which can introduce processing overhead, inconsistent user experience, and increased network traffic.

There is also a technical challenge in enabling real-time, overlay-style presentation of dynamic guidance on resource-constrained terminals, such as wearable displays. Existing systems often send raw model output to the terminal and leave most of the interpretation and rendering to the local device. This not only increases computational burden on the terminal but also makes it difficult to guarantee that updates are timely and coherent with the conversational flow. It further complicates security and traceability, as there is no unified server-side mechanism to record the chain from raw input, through prompt generation, to visual output.

Therefore, there is a need for an improved computer-implemented system and server-side processing architecture that: (1) systematically acquires interaction information; (2) generates structured prompt sentences encoding conversation context and output constraints; (3) obtains and normalizes predictive feature values from a generative AI model; (4) deterministically transforms those values into visual presentation data; and (5) delivers pre-structured image or layout information enabling low-latency, overlay-style display on a terminal. Such a system should improve the overall functioning of the computer network by reducing endpoint processing complexity, stabilizing model interaction, and enhancing the timeliness and consistency of visual guidance in real-world, real-time communication scenarios.

The specific processing by the specific processing unit 290 of the data processing device 12 in Application Example 1 is realized by the following means.

The present invention provides a server comprising a processor configured to acquire interaction information from an information processing apparatus having a communication function, to generate instruction information as a prompt sentence based on the acquired interaction information, to input the generated prompt sentence into a generative AI model to predict personality features or impression features of a target individual, to store the interaction information and the personality features or impression features in an accumulation information structure in association with conversation identification information or user identification information, to normalize attribute values representing the personality features or impression features into quantitative indices and to generate visual presentation data by selecting a visualization format according to the quantitative indices, to generate image information or screen layout information by using the visual presentation data, and to transmit the generated image information or screen layout information via a communication path to a terminal having a display function and to output display control information to cause the terminal to perform real-time superimposed display or overlay display of the image information or the screen layout information on a display device of the terminal. This enables a technical improvement in computer functionality by centralizing context-aware prompt generation and feature normalization on the server, ensuring deterministic transformation from unstructured conversational streams into structured visual data, reducing processing and rendering complexity at the terminal, and providing low-latency, real-time overlay guidance that is tightly synchronized with ongoing interactions.

The term “system” refers to a combination of hardware and software components, including at least one processor and one or more terminals, that cooperatively execute functions defined in the claims.

The term “processor” refers to a hardware computing element, such as a central processing unit or a processing core, configured by program instructions to execute arithmetic, logical, control, and input/output operations.

The term “information processing apparatus” refers to an electronic device, such as a computer or communication terminal, that is capable of executing software and processing digital data.

The term “communication function” refers to a capability of an information processing apparatus to send and receive data over a wired or wireless communication network according to one or more communication protocols.

The term “interaction information” refers to digital data representing exchanges between two or more entities, including at least one of text messages, audio-derived text, or other communication content obtained through a communication application.

The term “instruction information” refers to data that specifies conditions, constraints, and desired output formats for an information processing operation, and includes, in particular, a prompt sentence provided to a generative AI model.

The term “prompt sentence” refers to a structured text string that includes at least a portion of interaction information and model instructions, and that is input to a generative AI model to cause the model to generate a prediction or other output.

The term “generative AI model” refers to a trained machine learning model, such as a neural network-based language model, that generates output data including text or structured values in response to a given prompt sentence.

The term “target individual” refers to a person or entity whose personality features or impression features are to be inferred from interaction information by the generative AI model.

The term “personality features” refers to characteristics inferred for the target individual from interaction information, including at least one of behavioral tendencies, emotional tendencies, and interpersonal styles, represented as qualitative or quantitative data.

The term “impression features” refers to attributes describing how the target individual may be perceived by others, including at least one of perceived mood, attitude, and engagement level, represented as qualitative or quantitative data.

The term “accumulation information structure” refers to a storage arrangement, such as a database or data table, in which interaction information and associated prediction results are recorded in a logically organized manner.

The term “conversation identification information” refers to data, such as a conversation ID or session ID, that uniquely identifies a conversation instance among multiple conversations.

The term “user identification information” refers to data, such as a user ID or account ID, that uniquely identifies a user among multiple users.

The term “attribute values” refers to numerical or categorical values that represent respective aspects of the personality features or impression features inferred for the target individual.

The term “quantitative indices” refers to numerical values derived from attribute values, normalized into a predetermined range or scale for consistent processing and comparison.

The term “visual presentation data” refers to intermediate data that specifies one or more visualization parameters, including at least one of colors, shapes, and layouts, for representing the quantitative indices in a visual form.

The term “visualization format” refers to a predetermined type of visual representation, such as a bar graph, icon set, or color-coded indicator, selected according to the quantitative indices.

The term “image information” refers to data representing a complete or partial visual frame, such as raster image data or vector graphic data, that can be rendered on a display device.

The term “screen layout information” refers to data defining positions, sizes, and arrangements of one or more visual elements on a display screen, including at least one of panels, icons, and text fields.

The term “communication path” refers to a wired or wireless transmission route, including intermediate network infrastructure, through which data is exchanged between the server and a terminal.

The term “terminal” refers to an endpoint device having a display function and communication capability, including at least one of a portable terminal device and a wearable display device, that presents information to a user.

The term “display function” refers to a capability of a device to output visual information to a user through a screen, projection surface, or head-mounted display.

The term “portable terminal device” refers to a handheld or mobile electronic device, such as a smartphone or tablet, that includes processing, communication, and display capabilities.

The term “wearable display device” refers to an electronic device that can be worn on the body, such as head-mounted displays or smart glasses, and that includes a display configured to present visual information within the user's field of view.

The term “display device” refers to a hardware component, such as a liquid crystal display, organic light-emitting diode display, or projection module, that visually presents image information or screen layout information.

The term “display control information” refers to data specifying how visual information is to be rendered on a display device, including timing, position, layering, and update behavior.

The term “real-time” refers to processing and presentation with a latency sufficiently low that a user perceives the response as substantially immediate relative to an ongoing interaction.

The term “superimposed display” refers to a presentation mode in which visual information is drawn on top of other content on the same display area, without completely obscuring the underlying content.

The term “overlay display” refers to a presentation mode in which additional visual elements are rendered as an overlaid layer on an existing screen or field of view, so that both base content and overlay content are simultaneously visible.

The term “time-series history” refers to a sequence of interaction information ordered by occurrence time, representing the chronological flow of a conversation.

The term “utterance” refers to a unit of interaction information corresponding to one message or one segment of speech converted into text.

The term “conversation context information” refers to a set of one or more utterances selected from the time-series history and used together to represent the situational context for analysis or prediction.

The term “estimation conditions” refers to constraints or parameters, specified in a prompt sentence, that instruct the generative AI model on how to infer personality features or impression features.

The term “output format” refers to a specification, included in a prompt sentence, that instructs the generative AI model regarding the structure, type, or arrangement of its output.

The term “graphic information” refers to data elements defining visual attributes, including at least hue information, shape information, and arrangement information, for rendering one or more graphic elements.

The term “hue information” refers to data specifying one or more colors or color ranges used to visually represent quantitative indices or other attributes.

The term “shape information” refers to data specifying geometric forms, such as bars, circles, or polygons, used to represent quantitative indices or other attributes.

The term “arrangement information” refers to data specifying positions, alignment, layering, or spatial relationships among graphic elements and text elements in the visual information.

The term “graphics processing mechanism” refers to a hardware or software component, such as a graphics processing unit or a rendering engine, configured to generate or manipulate visual data.

The term “drawing library” refers to a software library that provides functions for creating and rendering shapes, text, and other visual elements to form visual information.

The term “visual information” refers to a combination of graphic elements and character elements generated from visual presentation data, configured to visually represent quantitative indices and recommended response contents.

The term “graphic elements” refers to visually rendered components, such as bars, icons, or charts, that represent quantitative indices or other numerical attributes.

The term “character elements” refers to text-based components, such as labels or explanatory messages, that describe recommended response contents or summaries of personality features or impression features.

The term “recommended response contents” refers to instructions or suggestions, derived from personality features or impression features, that indicate how a user should respond or interact in a given situation.

The term “output data” refers to data generated by the processor for transmission to the terminal, including at least visual information and associated control parameters for real-time update and display.

In one embodiment, a server, a terminal, and a user cooperate to implement the claimed system. The server executes software on one or more hardware processors, such as central processing units operating on a general-purpose computing platform or a cloud computing platform.

The terminal is a computing device having a display function, such as a smartphone, a tablet, or a head-mounted display device including smart glasses. The user operates the terminal and communicates with other persons through a communication application executed by the terminal and/or another information processing apparatus.

The server uses conventional hardware components, such as a processor, a main memory, a nonvolatile storage device, and a network interface, to execute a server application. The server application runs on an operating system, such as a server operating system, and uses a web framework, such as a script-based web framework, to provide network communication functions. The server accesses a data storage system, such as a relational database management system or a document-oriented database system, to implement an accumulation information structure used to store interaction information, conversation identification information, user identification information, and associated personality features and impression features.

The server centrally implements a pipeline that converts unstructured conversational text into normalized quantitative indices, and then converts the normalized indices into visual presentation data. The server uses a generative AI model in the form of a neural network-based language model executing on a machine learning inference platform. In one embodiment, the generative AI model is realized as a transformer architecture including multi-head self-attention layers, feed-forward layers, and layer normalization, pre-trained on large-scale text corpora and optionally fine-tuned on domain-specific conversational data. The server accesses the generative AI model through an application programming interface provided by a machine learning service provider.

The server defines a specific data structure for interaction information. The server stores each utterance as a record including fields such as a conversation identifier, a user identifier, a message text field, a timestamp field, and a processing status field. The server links utterances belonging to a same conversation via the conversation identifier and stores them in time-series order according to the timestamp. The server further defines a feature record structure including fields for personality features and impression features. The server stores attributes such as stress level, friendliness, openness, and other dimensions as continuous-valued features in a normalized numerical range-for example, between 0.0 and 1.0. By storing the personality features and impression features in a normalized numerical space, the server enables efficient querying, aggregation, and visualization.

The server generates a prompt sentence in a structured manner rather than constructing it manually for each interaction. The server retrieves a predetermined number of most recent utterances from the time-series history of a conversation, for example the last five to ten utterances, and aggregates them into conversation context information. The server then applies a template rule that defines an instruction section, a context section, and an output specification section. For instance, the server constructs a prompt sentence such as:

“You are an assistant that analyzes customer messages for a communication support system. Analyze the following conversation text and infer the customer's personality and current impression. Then suggest how the staff should respond.

Conversation text: ‘Recently, work has been so busy that I'm really feeling stressed.’

Return the following items:
stress level (from 0.0 to 1.0)
friendliness (from 0.0 to 1.0)
summary of impression
recommended action for the staff.”

In another example, the server generates a prompt sentence such as:

“User conversation: ‘Recently, work has been so busy that I'm really feeling stressed.’ Based on this information, predict the user's personality and impression, and recommend how the staff should respond. Output in English as:
Current emotional state
Possible personality traits
Recommended communication style from a store staff member.”

The server embeds the conversation context, the estimation conditions, and the output format instruction into the prompt sentence according to predetermined template rules. This template-based construction ensures that the generative AI model receives explicit instructions regarding which features to infer and how to represent them, which improves the determinism and consistency of the outputs compared to naive, free-form prompts.

The server applies additional processing to the generative AI model to enhance technical performance. The server defines a constrained output space by instructing the generative AI model to output values limited to specified ranges and formats. The server optionally applies post-processing rules that parse the generative AI model output and detect deviations from the specified format. If the output deviates beyond a tolerance threshold, the server triggers a secondary prompt sentence that explicitly corrects or re-asks the generative AI model for conformant output. By controlling output formats and enforcing structural constraints via prompt design and post-processing rules, the server reduces parsing errors, improves prediction reliability, and reduces the need for repeated network calls.

In an embodiment, the generative AI model is trained using a supervised learning procedure. The server (or an associated training system) prepares training data that pairs conversational text segments with labeled personality features and impression features. The training procedure uses an objective function such as a cross-entropy loss function for categorical labels and a mean squared error function for continuous-valued indices, or a combined loss that weighs classification and regression tasks. The training system updates model parameters by stochastic gradient descent or an adaptive optimization algorithm such as an adaptive moment estimation method. The training system optionally uses regularization techniques, such as dropout and weight decay, and data augmentation techniques, such as paraphrasing or noise injection, to improve generalization. By explicitly defining this training method, the system ensures the generative AI model is tuned to produce high-quality predictions for the intended domain.

The server improves computer technology by centralizing computationally intensive processes and standardizing data structures. The server normalizes personality features and impression features into quantitative indices and stores them in a compact numeric format. This normalization reduces data volume when transmitting analysis results to the terminal and simplifies the downstream visualization logic. The server further maps these indices to visualization parameters. For example, the server uses a non-linear mapping function to convert a stress level value between 0.0 and 1.0 into a hue angle in a color wheel, where 0.0 corresponds to green and 1.0 corresponds to red. Similarly, the server maps friendliness to icon shape selection and maps overall intensity to the thickness or length of a bar element. The server precomputes these mappings and generates visual presentation data that describes the hue, shape, placement, and textual labels for each visual element.

The server uses a graphics processing mechanism or a drawing library to transform the visual presentation data into image information or screen layout information. In one embodiment, the server executes a rendering engine such as a headless browser or a canvas-based drawing library. The server generates a vector-based representation of the visual elements and rasterizes it into an image with a predetermined resolution optimized for the target terminals. The server may generate multiple layout variants optimized for different display form factors, such as smartphone screens and narrow fields of view for smart glasses. By performing rendering on the server side, the system reduces the computational load on the terminal, which is especially beneficial when the terminal has limited processing capabilities.

The terminal receives pre-structured image information or screen layout information together with display control information from the server. The terminal uses local modules for decompression, decoding, and light-weight compositing, which require less computation than full-featured visualization or model inference. Because the server has already normalized the indices and selected the visualization format, the terminal avoids heavy calculations for mapping raw model output to visible elements. This architecture reduces power consumption and resource utilization on the terminal and lowers latency for visual updates, thereby improving the responsiveness of the overall system.

The user views the visual information presented by the terminal while engaging in communication with another party. The user can, for example, see a small overlay in a corner of a head-mounted display indicating “High stress-Suggest relaxing items,” derived from an inferred stress level close to 1.0. This presentation is superimposed on other content on the display, such as a chat interface or a list of products. Because the overlay information is generated on the server based on standardized indices and rules, the update timing and positioning can be carefully controlled. The user thereby receives consistent and real-time visual guidance during interaction, without needing to operate separate analysis tools.

The server achieves technical effects beyond mere automation of human mental steps. The server reduces communication load by transmitting compact, normalized indices or pre-rendered visual elements rather than raw conversational history or raw generative AI model outputs. The server reduces system-wide processing time by controlling prompt formats and by avoiding redundant re-analysis of unchanged conversation context, for example by caching intermediate representations of context blocks that are reused between multiple calls to the generative AI model. The server increases prediction accuracy and stability by employing structured prompts and range-restricted outputs, which reduce the variance of generative responses that must be interpreted downstream. These improvements directly affect the functioning of the computer network and the devices involved, resulting in measurable reductions in latency, error rates, and resource consumption.

The server also uses processing techniques that are not conventional in purely rule-based or human-driven systems. Instead of relying only on sentiment lexicons or simple keyword matching, the server leverages high-dimensional latent representations produced by the multi-layer transformer network. The generative AI model internally encodes contextual relationships between words and phrases using attention mechanisms that compute weighted sums of token embeddings based on learned attention weights. This architecture enables the system to capture long-range dependencies and subtle patterns that are not readily encoded by manually designed rules. The server then restricts and interprets these high-dimensional outputs through its normalization and visualization modules, thereby realizing a hybrid architecture that combines learned representations with deterministic mapping logic.

In one variation, the server runs the generative AI model locally using an accelerated computing device, such as a graphics processing unit or a tensor processing unit, rather than invoking a remote machine learning service. In this case, the server maintains a local inference engine that loads the trained model parameters into device memory. The server batches multiple prompt sentences and performs batch inference to increase throughput and reduce per-request overhead. The server adjusts batch sizes and scheduling parameters depending on observed latency and resource utilization. By tuning these computational parameters, the server can provide predictable response times even when multiple conversations are processed concurrently.

In another variation, the server adapts the visualization rules depending on the type of terminal. For a smartphone, the server uses a larger, more detailed layout including legends and explanatory texts. For a head-mounted display, the server uses smaller, minimal indicators to avoid obstructing the user's field of view. The server uses device capability information, such as screen resolution, color depth, and supported graphic formats, to select an appropriate rendering profile. This device-aware rendering reduces bandwidth consumption, because the server can generate smaller images or simplified layouts for more constrained devices.

The terminal may be implemented using various operating systems, such as a mobile operating system or an embedded real-time operating system, and may execute a native application or a web application. The terminal application includes a communication module that maintains a secure connection with the server, a decoding module for receiving and interpreting image information or screen layout information, and a rendering module that performs final compositing of overlays onto the display. The terminal may optionally store a cache of recently used icons or templates to accelerate rendering and reduce repeated downloads. The user interacts with the terminal through an input device such as a touch screen, a hardware button, or a voice command interface, for example to provide feedback regarding the accuracy of the inferred personality features or impression features.

The user may provide feedback to the server indicating that the displayed impression was accurate or inaccurate. The server records this feedback in association with the corresponding conversation identification information, user identification information, and predicted indices. The server may use this feedback offline to retrain or fine-tune the generative AI model, for example by adjusting loss weights for particular feature dimensions or rebalancing training samples. The server may also adapt prompt templates based on feedback statistics, such as increasing or decreasing the detail of output format instructions. In this way, the server continuously refines the behavior of the generative AI model and improves the technical performance of the prediction and visualization pipeline.

In an alternative embodiment, the server applies domain-specific rules to the normalized quantitative indices before generating visual presentation data. For example, the server may apply a smoothing algorithm, such as an exponential moving average over recent predictions, to avoid flickering or abrupt changes in the displayed stress indicator. The server may also apply threshold-based hysteresis to change color ranges more slowly than instantaneous index fluctuations. These algorithms improve the stability of the visual output and reduce cognitive load on the user, while at the same time reducing the frequency of updates that need to be transmitted to the terminal, thus lowering network traffic.

The system therefore provides a concrete and specific improvement in the functioning of a distributed computer environment by defining particular data structures for interaction information and features, by using a structured prompt sentence to control behavior of a generative AI model, by normalizing and mapping model outputs to visual parameters on the server, and by delivering pre-structured image or layout information optimized for real-time overlay display on a terminal. The server, the terminal, and the user cooperate through these mechanisms to achieve high-speed, accurate, and resource-efficient presentation of personality-related guidance during real-world communication scenarios.

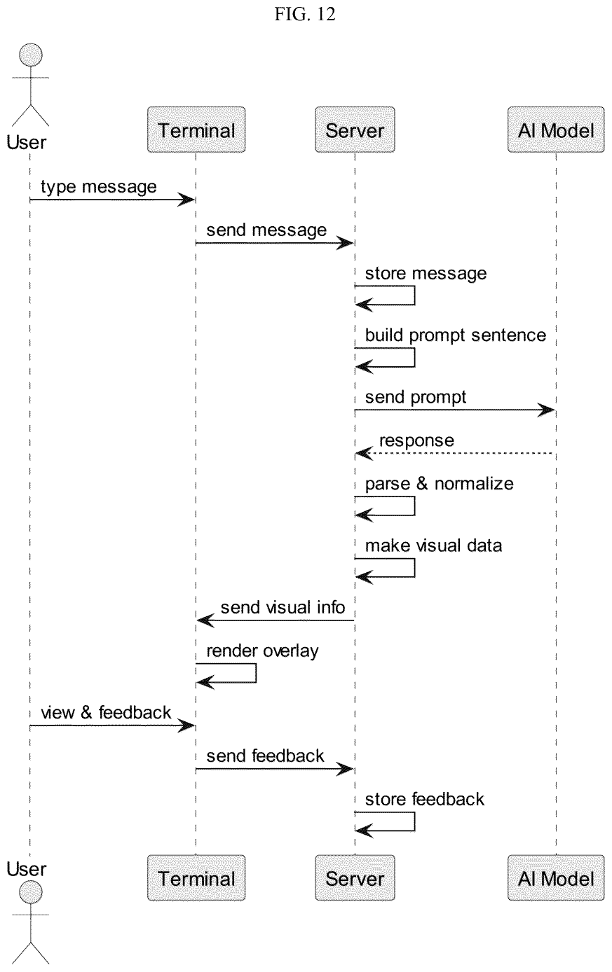

The following describes the processing flow using FIG. 12.

### Step 1

The user operates a communication application on the terminal and inputs an utterance as text.

The terminal sends the utterance, together with a conversation identifier, a user identifier, and a timestamp, to the server via a network interface.

The input is raw interaction information containing at least one text message generated by the user.

The output is a structured data packet including the message text, conversation identifier, user identifier, and timestamp fields formatted in a predefined schema.

### Step 2

The server receives the structured data packet from the terminal through an application programming interface.

The server verifies an authentication token and validates a message format of the incoming packet.

The input is the structured data packet containing interaction information and metadata.

The server parses the packet, extracts the message text and metadata, and writes them as a new record into an accumulation information structure such as a database table for utterances.

The output is a stored utterance record associated with a processing status flag indicating that analysis is pending.

### Step 3

The server retrieves a time-series history of utterances associated with the same conversation identifier from the accumulation information structure.

The input is a conversation identifier and a query condition specifying a number of recent utterances.

The server sorts the retrieved utterances by timestamp and selects a predetermined number of most recent messages as conversation context information.

The server concatenates the message texts into a single context string, optionally inserting delimiters or speaker tags.

The output is a context data object that includes the context string and corresponding identification information.

### Step 4

The server generates a prompt sentence based on the context data object and a predefined prompt template.

The input is the context data object and a template defining instruction sentences, context insertion positions, and output specification sentences.

The server inserts the context string into the template section labeled as conversation text and appends explicit instructions for required output items and value ranges.

For example, the server generates a prompt sentence such as:

“You are an assistant that analyzes customer messages for a communication support system. Analyze the following conversation text and infer the customer's personality and current impression. Then suggest how the staff should respond.

Conversation text: ‘Recently, work has been so busy that I'm really feeling stressed.’

Return the following items:
stress level (from 0.0 to 1.0)
friendliness (from 0.0 to 1.0)
summary of impression
recommended action for the staff.”

The output is a complete prompt sentence string ready to be sent to a generative AI model.

### Step 5

The server transmits the prompt sentence to the generative AI model via a machine learning inference interface.

The input is the prompt sentence string and model invocation parameters including a model name, a temperature parameter, and a maximum token count.

The server establishes a secure connection to the inference interface, constructs a request body containing the prompt sentence, and sends the request.

The generative AI model processes the prompt sentence using a neural network architecture and returns a generated response string describing personality features and impression features.

The output is the model response string received by the server from the generative AI model.

### Step 6

The server parses the model response string to extract attribute values for personality features and impression features.

The input is the model response string that may contain textual descriptions and numeric expressions.

The server applies a parsing module that identifies target items such as stress level, friendliness, summary of impression, and recommended action based on keyword patterns or structural cues specified in the prompt template.

The server converts extracted numeric expressions into floating-point values and stores them in an intermediate feature structure, while storing textual summaries and recommendations as character strings.

The output is a feature data object including raw attribute values for personality features and impression features.

### Step 7

The server normalizes the raw attribute values into quantitative indices within predetermined ranges.

The input is the feature data object containing raw numeric and textual values.

The server applies normalization functions, such as linear scaling or clipping, to map raw values into a standardized interval, for example between 0.0 and 1.0 for each feature dimension.

The server stores the normalized values as quantitative indices in a feature record in the accumulation information structure, associated with the conversation identifier and user identifier.

The output is a normalized feature record containing quantitative indices and linked identification information.

### Step 8

The server generates visual presentation data based on the quantitative indices.

The input is the normalized feature record including indices such as stress level and friendliness.

The server selects a visualization format, for example a colored bar, an icon, or a simple chart, according to predefined mapping rules that associate index ranges with visual types.

The server calculates visualization parameters such as hue, brightness, bar length, icon selection, and text labels using mapping functions applied to the indices.

The output is visual presentation data describing visual parameters including color values, shape types, sizes, positions, and associated textual messages.

### Step 9

The server converts the visual presentation data into image information or screen layout information.

The input is the visual presentation data including geometric and textual parameters.

The server invokes a graphics processing mechanism or drawing library to render graphic elements, such as bars and icons, and character elements, such as labels and recommendations, onto a virtual canvas.

The server generates either a raster image file in a predetermined resolution or a structured layout description specifying positions and styles of elements.

The output is image information or screen layout information that can be directly used by the terminal for display.

### Step 10

The server transmits the generated image information or screen layout information to the terminal together with display control information.

The input is the image information or screen layout information and metadata including display priority and validity duration.

The server packages these data items into a transmission message, addresses the message to a specific terminal associated with the user or staff member, and sends the message via a communication path such as a secure network channel.

The output is a delivered message at the terminal side containing display-ready visual data and control parameters.

### Step 11

The terminal receives the message from the server and prepares the display of the visual information.

The input is the message including image information or screen layout information and display control information.

The terminal verifies message authenticity, decodes any compressed or encoded image data, and allocates drawing buffers or user interface components according to the control information.

The terminal determines a display region, such as an overlay area in a corner of the screen or field of view, based on the received layout instructions.

The output is a prepared rendering state containing decoded visual elements and layout positions.

### Step 12

The terminal renders the visual information on its display device in real time as an overlay or superimposed display.

The input is the prepared rendering state including visual elements and layout positions.

The terminal draws the graphic elements and character elements on top of existing application content, respecting z-order and transparency values to maintain visibility of underlying content.

The terminal updates the visual overlay when new visual information is received or when the conversation context changes, while removing or fading out outdated information.

The output is a displayed overlay on the terminal's display device that the user can view during ongoing interaction.

### Step 13

The user observes the overlay display on the terminal and adjusts behavior according to the presented information.

The input is the real-time visual overlay including indicators such as stress level and recommended action.

The user interprets the information, for example recognizing that the other party is under high stress, and modifies speech content, tone, or suggested items accordingly.

The user may optionally provide feedback through the terminal interface, indicating whether the presented personality features and impression features are accurate.

The output is human behavioral adjustment guided by the overlay and, optionally, feedback data that can be transmitted back to the server.

### Step 14

The server receives feedback from the terminal and updates stored records for future refinement.

The input is feedback data associated with conversation identification information, user identification information, and previously generated feature records.

The server stores the feedback in the accumulation information structure and may mark certain predictions as confirmed or unconfirmed.

The server can later use this feedback as labeled data to retrain or fine-tune the generative AI model or to adjust prompt sentence templates and normalization rules.

The output is an updated data store that supports gradual improvement of prediction accuracy and visualization behavior over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented feedback systems, processing of user interaction data, such as messages or chat logs, is typically limited to simple keyword matching or coarse sentiment scoring. Such systems often treat text as unstructured strings and do not perform systematic preprocessing, feature extraction, or structured prompting for advanced models. As a result, the mapping from interaction data to user characteristics and impressions is inaccurate, opaque, and difficult to maintain or extend. Furthermore, existing systems frequently generate static and generic visual feedback that is not tightly coupled to machine-interpretable prediction results, thereby limiting the usefulness of the feedback and degrading user experience.

From the standpoint of computer technology, these limitations manifest as inefficient use of computational resources, lack of modularity in the processing pipeline, and suboptimal utilization of machine learning and generative models. In particular, conventional architectures do not clearly define how preprocessed interaction data and extracted feature quantities should be combined with prompt sentences to drive a generative model in a predictable and controllable manner. Additionally, conventional systems do not provide a standardized way to transform prediction results into structured data and then into visual parameters that can be programmatically rendered, nor do they adequately support representation of temporal changes in user characteristics and impressions in a form suitable for automated visualization.

Accordingly, there is a need for an improved computer-implemented system that (i) systematically preprocesses and structures interaction data, (ii) generates and supplies prompt sentences and associated feature quantities to a generative model in a controlled manner, (iii) obtains prediction results in a structured format suitable for downstream processing, and (iv) converts those prediction results into parameterized visual information, including temporal indices, that can be efficiently rendered and presented on terminal devices. Such a system should improve the overall performance, interpretability, and scalability of the underlying computing processes, thereby constituting an improvement in computer technology itself rather than a mere automation of mental evaluation.

The specific processing by the specific processing unit 290 of the data processing device 12 in Example 2 is realized by the following means.

The present invention provides a server comprising a processor configured to acquire interaction data from an information processing device, store the interaction data in a storage device, perform preprocessing on the interaction data including at least a character removal process, a normalization process, and a segmentation process, extract feature quantities including occurrence frequency information, evaluation information, and statistical information from the preprocessed interaction data and generate a numerical vector, generate a prompt sentence based on information including the numerical vector and the interaction data for estimating a characteristic and an impression of a user, input the prompt sentence and the feature quantities into a generative information processing model to generate prediction information regarding the characteristic and the impression of the user, associate the prediction information with a predetermined classification scheme to determine a characteristic category and an impression category, convert the characteristic category and the impression category into visual parameters including at least a color attribute, a shape attribute, and a layout attribute, generate graphic information or image information based on the visual parameters, and transmit the graphic information or image information via a communication network to a terminal device having a display function so as to cause the terminal device to present the graphic information or image information on a display surface. This enables an integrated and technically structured processing pipeline in which raw interaction data are transformed through defined computational stages—preprocessing, feature extraction, structured prompting of a generative model, structured prediction, and parameterized visual rendering—thereby improving the accuracy, controllability, and efficiency of computer-based evaluation and visualization of user characteristics and impressions, as well as enabling scalable, machine-interpretable feedback that enhances the functioning of the underlying computer system.

The term “interaction data” refers to information representing exchanges between a user and an information processing device, including but not limited to text messages, chat logs, comments, and other linguistic inputs provided by the user through a communication interface.

The term “information processing device” refers to an electronic apparatus that performs at least one of data acquisition, data storage, data processing, or data transmission, and that is capable of communicating interaction data with a server via a communication network.

The term “storage device” refers to a hardware or virtual component configured to store data in a non-transitory manner, including but not limited to magnetic storage, semiconductor storage, optical storage, or cloud-based storage resources.

The term “preprocessing” refers to a series of operations applied to raw interaction data to normalize and structure the data for further analysis, including at least a character removal process, a normalization process, and a segmentation process.

The term “character removal process” refers to an operation that removes unnecessary or predefined characters, symbols, control codes, or formatting elements from interaction data in order to reduce noise and improve subsequent processing.

The term “normalization process” refers to an operation that unifies the representation of interaction data, including at least standardizing character case, white space, punctuation, or encoding formats, to provide a consistent textual form.

The term “segmentation process” refers to an operation that divides interaction data into units, such as sentences, tokens, or other linguistic segments, to facilitate feature extraction and analysis.

The term “feature quantities” refers to measurable values derived from interaction data, including but not limited to occurrence frequency information, evaluation information, and statistical information, which serve as inputs to analytical or predictive models.

The term “occurrence frequency information” refers to data indicating how often particular elements, such as tokens, terms, or patterns, appear within interaction data.

The term “evaluation information” refers to data representing a qualitative or quantitative assessment of interaction data, including but not limited to sentiment scores, polarity indicators, emotional ratings, or other evaluative metrics.

The term “statistical information” refers to numerical descriptors of interaction data, including but not limited to counts, averages, variances, distributions, and other statistical measures.

The term “numerical vector” refers to an ordered set of numeric values representing feature quantities extracted from interaction data, suitable for processing by computational models such as machine learning or generative models.

The term “prompt sentence” refers to a machine-readable textual instruction constructed based on interaction data and feature quantities, and provided as input to a generative information processing model in order to guide generation of prediction information.

The term “generative information processing model” refers to a computational model, such as a generative artificial intelligence model, that generates output information, including prediction information, in response to input data such as prompt sentences and feature quantities.

The term “prediction information” refers to output data generated by a generative information processing model, representing at least inferred characteristics and impressions associated with a user based on interaction data.

The term “classification scheme” refers to a predetermined set of categories, labels, or taxonomies used to organize and interpret prediction information related to user characteristics and impressions.

The term “characteristic category” refers to a class or label within the classification scheme that represents a type of user attribute, such as a personality trait or behavioral tendency, derived from prediction information.

The term “impression category” refers to a class or label within the classification scheme that represents a perceived emotional state, attitude, or evaluative impression of a user, derived from prediction information.

The term “visual parameters” refers to data defining visual properties used to generate graphic or image information, including at least color attributes, shape attributes, and layout attributes.

The term “color attribute” refers to a parameter specifying color-related properties, such as hue, saturation, brightness, or color codes, used in the generation of visual information.

The term “shape attribute” refers to a parameter specifying geometric or symbolic forms, such as icons, figures, or graphical elements, used in the generation of visual information.

The term “layout attribute” refers to a parameter specifying spatial arrangement, positioning, size, or relational placement of visual elements within graphic or image information.

The term “graphic information” refers to data representing visual content composed of graphical elements, such as shapes, icons, charts, or text overlays, suitable for rendering on a display device.

The term “image information” refers to data representing raster or vector images, including still images or frames, which are suitable for visual presentation on a display device.

The term “communication network” refers to an infrastructure enabling data transfer between devices, including but not limited to wired networks, wireless networks, local area networks, wide area networks, or public communication networks.

The term “terminal device” refers to an end-user apparatus equipped with a display function and a communication function, such as a mobile device, a computing terminal, or a display-equipped appliance, capable of receiving and presenting visual information.

The term “display function” refers to a capability of a terminal device to visually render graphic information or image information on a display surface using a display unit such as a liquid crystal display, an organic light-emitting display, or another visual output component.

The term “display surface” refers to a physical or virtual area of a display unit on which visual information is presented to a user.

The term “structured data format” refers to an arrangement of data that conforms to a predefined schema or syntax, such as a key-value representation, a hierarchical representation, or a tabular representation, enabling machine parsing and programmatic processing.

The term “output format specification information” refers to data included in a prompt sentence that instructs a generative information processing model regarding the desired structure, syntax, or representation of its output, including specification of a structured data format.

The term “temporal change index” refers to a value or set of values indicating variation of a characteristic, impression, or related metric over time for a given user or interaction sequence.

The term “visual information that continuously represents a change of the index” refers to graphic or image information that depicts temporal variation of a temporal change index in a continuous or sequential manner, such as through graphs, timelines, animations, or other visual representations of time-dependent data.

In an embodiment, a server cooperates with one or more terminals and users to implement the claimed system. The server includes at least one processor, a memory device, a non-transitory storage device, and one or more communication interfaces. The terminal includes at least one processor, a display unit, an input unit such as a touchscreen or a keyboard, a memory device, and a communication interface. The user operates the terminal to input interaction data, and the server processes the interaction data to generate prediction information and visual information, which the terminal displays to the user.

The server uses general-purpose hardware such as a central processing unit and, in certain embodiments, a graphics processing unit in order to execute software components implementing natural language processing, feature extraction, and inference of a generative AI model. The server executes an operating system such as a general-purpose server operating system, and runs an application framework such as a web application framework or an application server. The server stores interaction data and intermediate processing results in a database system, which may be a relational database system or a non-relational database system.

The server employs software libraries for natural language processing and data analysis. In one embodiment, the server uses a natural language processing library to perform tokenization, stemming or lemmatization, and stopword removal. The server uses a data analysis library and a machine learning library to compute numerical feature quantities such as term frequency-inverse document frequency values, sentiment scores, and statistical descriptors of interaction data. The server uses a deep learning framework to implement and execute a generative AI model. The server thereby performs tangible data processing operations that are closely tied to specific data structures and hardware resources, resulting in technical improvements such as reduced storage requirements, lower communication load, and increased processing throughput.

The server acquires interaction data provided by the user through the terminal. The terminal presents a communication application interface that allows the user to input text messages or chat content. The terminal converts the user input into encoded text data and transmits the text data to the server via a communication network. The server receives the interaction data at an application programming interface endpoint implemented by the application framework and stores the raw interaction data in the storage device. The server stores each interaction record with associated metadata such as a user identifier, a timestamp, and a session identifier, thereby allowing efficient indexing and retrieval of interaction data.

The server performs preprocessing on the stored interaction data. The server removes predetermined classes of characters that are considered noise, such as markup tags, control codes, repeated punctuation, and unsupported symbols. The server normalizes the interaction data by converting characters to a canonical form, unifying spacing, and applying consistent encoding. The server segments the interaction data into linguistic units such as sentences and tokens using algorithms provided by the natural language processing library. For example, the server uses a rule-based sentence splitter and a statistical tokenizer. The server writes the preprocessed and segmented data into a separate data structure in the storage device, such as a table of tokens associated with each interaction record.

The server extracts feature quantities from the preprocessed interaction data. The server calculates occurrence frequency information by constructing a term-document matrix, in which each row corresponds to an interaction instance and each column corresponds to a vocabulary term. The server may compute raw term frequencies or weighted values such as term frequency-inverse document frequency. The server also computes evaluation information such as sentiment scores, by applying a sentiment analysis model to each interaction instance. The server generates statistical information such as the average sentence length, the variance of token counts, the distribution of part-of-speech tags, and the ratio of first-person pronouns to total tokens. The server aggregates these feature quantities into a numerical vector for each interaction instance or for each user. The numerical vector is stored in memory or in a dedicated feature table, and is represented as a dense or sparse numerical array suitable for input to a machine learning model.

The server constructs a prompt sentence to guide the generative AI model. The server combines selected feature quantities and the original or normalized interaction text into a formatted textual instruction. For example, the server generates a prompt sentence such as:

“Analyze the following user conversation and predict the user's personality traits and impressions. Conversation: Today was a really fun day. Output the result as: traits: [list]; impressions: [list].”

In another example, the server generates a prompt sentence such as:

“From the conversation below, infer the user's traits and impressions, and express them using brief labels. Conversation: Today was a really fun day.”

The server includes, in the prompt sentence, explicit output format specification information that instructs the generative AI model to return its results in a structured textual format, such as labeled lists or key-value pairs, so that the server can reliably parse the prediction information. By constructing prompt sentences in this structured manner, the server improves the determinism and parseability of the model's output, thereby reducing post-processing errors and computational overhead.

The server implements the generative AI model as a trained neural network. In one embodiment, the server uses a transformer-based sequence-to-sequence architecture having multiple self-attention layers, feed-forward layers, and layer normalization operations. The server stores model parameters such as weight matrices and bias vectors in the storage device, loads them into memory, and performs inference using the deep learning framework. The generative AI model receives the prompt sentence as a sequence of token identifiers. The server encodes the prompt sentence using a subword tokenizer, forms input embeddings, and processes the embeddings through the transformer layers to generate an output token sequence representing prediction information.

In another embodiment, the server uses a hybrid architecture in which the numerical feature vector is concatenated with a text-based representation and supplied as an additional conditioning input to the generative AI model. For example, the server converts sentiment scores and statistical descriptors into a compact textual or numerical representation and appends it to the prompt sentence. This multi-channel conditioning enables the generative AI model to exploit structured numerical features in addition to raw text, improving prediction accuracy and robustness.

The server trains the generative AI model using supervised learning. During training, the server uses a training dataset containing pairs of interaction data and ground-truth labels representing user characteristics and impressions. The server encodes each training interaction into a prompt sentence and uses the associated labels as target output text. The server defines a loss function, such as a cross-entropy loss over the output token sequence, and updates the model parameters using gradient-based optimization such as stochastic gradient descent or a variant thereof. The server may employ regularization techniques and data augmentation techniques, for example by paraphrasing interaction texts or perturbing token order within permissible limits, to improve generalization and reduce overfitting. By defining explicit loss functions and optimization strategies, the server controls the internal behavior of the generative AI model and tailors it for the specific prediction task of inferring user characteristics and impressions.

The server parses the output of the generative AI model to obtain prediction information. The server applies string parsing rules or a lightweight parser to the generated output text, extracts trait labels and impression labels, and maps them to elements of a predetermined classification scheme stored in the storage device. The server may perform a post-classification step using a deterministic rule set or an auxiliary classifier to standardize synonymous labels into canonical categories. This mapping ensures that prediction information is stored as structured data, which can then be combined and compared across users and across time.

The server converts the structured prediction information into visual parameters. The server maintains a mapping table between characteristic categories and impression categories, on the one hand, and visual attributes such as colors, shapes, icons, and layout templates, on the other hand. For example, the server associates an “optimistic” trait with a high-brightness, warm color palette, and a “calm” impression with a cool color palette and smooth geometric shapes. The server generates a set of visual parameters that specify color codes, icon identifiers, geometric primitives, text labels, positions, and sizes within a visual composition.

The server generates graphic information or image information based on the visual parameters using a rendering module. In one embodiment, the server uses a general-purpose graphics library to draw shapes, icons, and text onto an off-screen buffer, resulting in a raster image. The server may use primitive drawing operations such as drawing circles, rectangles, lines, and text strings at positions defined by the layout attributes. In another embodiment, the server generates a vector graphic representation by constructing a document in a structured graphic format. By parameterizing the visual generation, the server reduces the amount of data that must be transmitted to the terminal and enables resolution-independent rendering.

The server optionally generates visualizations of temporal change. The server maintains, for each user, a history of prediction information over time. The server computes a temporal change index for each characteristic category and impression category, such as a moving average or a smoothed time series. The server converts these indices into visual parameters specifying, for example, a line chart, a bar chart, or a timeline. By incorporating temporal indices into visual parameters, the server enables visualization of how the user's characteristics and impressions evolve over time, and does so using a standardized and computable representation.

The server transmits the generated graphic or image information to the terminal using the communication interface. The terminal receives the information, decodes it, and renders it on the display unit. The terminal may display an avatar, a chart, or another graphical element that reflects the user's current or historical characteristics and impressions. The user views this visual information and can interpret the feedback without needing to understand the internal computational processing.

The described configuration provides technical effects beyond mere automation of human judgment. The server reduces processing latency and improves throughput by performing preprocessing and feature extraction in a structured manner, so that the generative AI model operates on normalized and informative inputs, thereby reducing the length and complexity of model-generated outputs required to represent prediction information. The server improves memory efficiency and data management by storing feature quantities and classification results in compact numerical and categorical forms, rather than retaining only raw unstructured text. The server reduces communication load by transmitting parameterized visual representations or compressed image data instead of transmitting entire analytic pipelines or verbose text explanations.

The server also improves prediction accuracy and stability by using a specific combination of text preprocessing, feature extraction, structured prompt sentence construction, and classification mapping. This combination yields a more predictable and controllable interaction with the generative AI model than unstructured prompting, which in turn reduces the need for iterative back-and-forth communication between the server and the model. The server thereby achieves a reduction in total computational cycles and network round trips.

The system implements processing flows and internal rules that are not simply human workflows executed by a computer. For example, the server applies non-intuitive segmentation and feature-extraction rules tailored to statistical properties of large-scale interaction data, chooses feature subsets that are optimized for generative sequence modeling, and uses formal loss functions and gradient-based optimization, which are not processes that a human could feasibly perform manually at scale. The server further enforces constraints on the generative AI model's output via output format specification information in the prompt sentence, enabling deterministic parsing and structured storage. These technical mechanisms collectively improve the functioning of the computer system itself by enabling more efficient and accurate use of computational resources and by providing a robust, machine-interpretable link between interaction data and visual output.

In another embodiment, the server uses an alternative neural architecture, such as a recurrent neural network with attention, or a hybrid model combining a transformer encoder with a simpler decoder. In yet another embodiment, the server replaces or supplements the generative sequence model with a discriminative classifier that receives the numerical feature vectors as input and outputs class probabilities for characteristic and impression categories; the server then integrates these probabilities into the prompt sentence to refine the generative model's prediction. The server can also vary the graphics generation method, for example by using a procedural graphics engine or a rule-based layout algorithm.

The terminal may be a mobile device, a tablet, a notebook computer, a desktop computer, or an embedded system with a display. The server may be implemented as a single physical machine or as a distributed system including multiple machines connected through a network. In some embodiments, intermediate processing modules, such as a dedicated feature-extraction service or a dedicated rendering service, may run on separate machines, while still falling within the scope of the system in which the server coordinates overall operation.

Through these embodiments and variations, the server, the terminal, and the user cooperate in a technically specific manner to transform raw interaction data into normalized, structured inputs, to apply a trained generative AI model using defined algorithms and data structures, and to generate parameterized visual outputs that are efficiently transmitted and rendered. This integrated design produces concrete technical benefits such as improved processing speed, increased prediction accuracy, reduced resource consumption, and enhanced reliability of computer-based visualization of user characteristics and impressions.

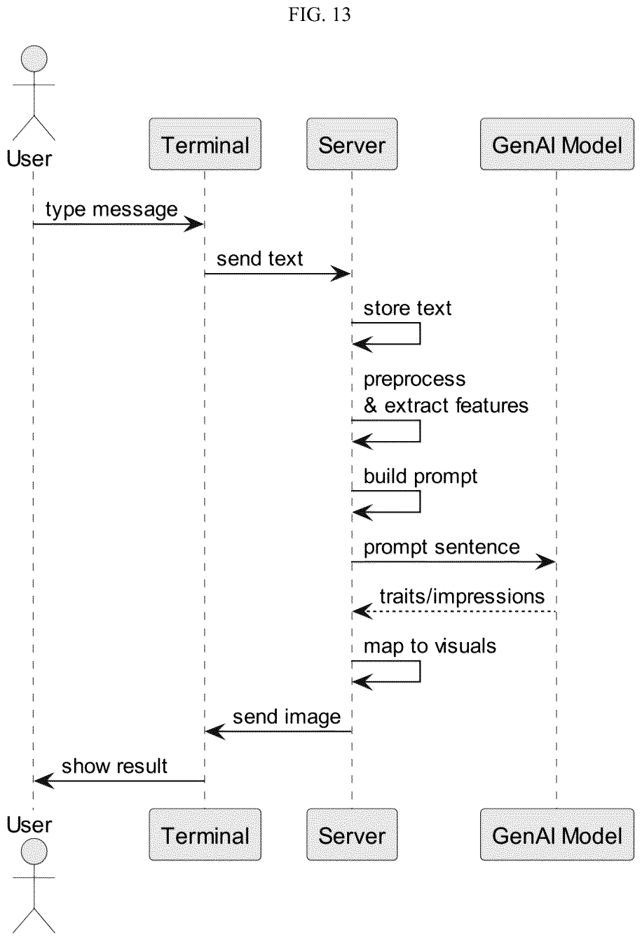

The following describes the processing flow using FIG. 13.

### Step 1

User operates the terminal to input interaction data.

User enters a text message, such as “Today was a really fun day.”, through a touchscreen or keyboard of the terminal.

User confirms the input by tapping a send button in a communication application running on the terminal.

Input: Raw textual input from the user's input device (characters, spaces, punctuation).

Output: Encoded text data inside the terminal's application buffer.

### Step 2

Terminal transmits the interaction data to the server.

Terminal packages the encoded text data together with metadata (user identifier, timestamp, session identifier) into a request object, for example a JSON payload.

Terminal sends the request object as an HTTP or similar protocol message via a communication interface over a network to a predefined endpoint of the server.

Input: Encoded text data and metadata in the terminal's memory.

Output: Network packet stream containing the request object, delivered to the server.

### Step 3

Server receives and stores the interaction data.

Server accepts the network packet stream through a communication interface and reconstructs the request object using a server-side application framework.

Server validates the structure and encoding of the received data and discards or corrects malformed elements.

Server writes the interaction text and associated metadata into a storage device, for example into a database record with fields such as interaction_id, user_id, timestamp, and raw_text.

Input: Network request object containing user text and metadata.

Output: Persistent data record stored in the server's storage device.

### Step 4

Server performs preprocessing on the stored interaction data.

Server retrieves the raw_text field from the storage device and loads it into main memory.

Server removes undesired characters, such as markup, control symbols, and repeated punctuation, by applying string operations and regular expression matching.

Server normalizes the text by converting characters to a standard case, unifying whitespace, and standardizing punctuation.

Server segments the normalized text into sentences and tokens using a natural language processing library, such as by invoking sentence boundary detection and tokenization functions.

Server stores the segmented tokens in an intermediate data structure indexed by interaction_id.

Input: Raw interaction text retrieved from the storage device.

Output: Normalized and tokenized representation of the interaction text, stored as a token list or equivalent structure.

### Step 5

Server extracts feature quantities from the preprocessed interaction data.

Server counts how many times each token appears in the interaction text and calculates occurrence frequency values for each token.

Server constructs a term-frequency or term frequency-inverse document frequency vector by mapping each token to a numerical dimension and filling vector components with the corresponding frequency values.

Server applies a sentiment or evaluation algorithm to the normalized text to compute sentiment polarity scores or other evaluative metrics, such as positivity, negativity, and subjectivity scores.

Server computes additional statistical information, such as average sentence length, variance of token counts, and ratios of specific token types (for example, first-person pronouns to total tokens).

Server aggregates the frequency values, sentiment scores, and statistical metrics into a numerical vector representing feature quantities for the interaction.

Input: Normalized and tokenized interaction data.

Output: Numerical feature vector including occurrence frequency information, evaluation information, and statistical information.

### Step 6

Server generates a prompt sentence for a generative AI model.

Server selects relevant portions of the original or normalized interaction text and combines them with elements of the numerical feature vector, such as sentiment labels or key statistics, according to a predetermined template.

Server constructs a textual instruction that describes the analysis task and specifies an expected output format.

For example, the server generates the prompt sentence:

“Analyze the following user conversation and predict the user's personality traits and impressions. Conversation: Today was a really fun day. Output the result as: traits: [list]; impressions: [list].”

Server formats the prompt sentence as a single string in a character encoding suitable for the generative AI model.

Input: Interaction text and numerical feature vector.

Output: Prompt sentence string ready to be supplied to the generative AI model.

### Step 7

Server supplies the prompt sentence and feature quantities to the generative AI model.

Server encodes the prompt sentence into token identifiers using a tokenizer compatible with the generative AI model.

Server, in some embodiments, appends a textual or numerical representation of selected feature quantities to the prompt to condition the model further.

Server passes the encoded prompt sentence, and optionally the additional feature representation, as input tensors to the generative AI model executed by a deep learning framework on a processor or accelerator.

Input: Prompt sentence string and numerical feature vector.

Output: Encoded model input tensors representing the prompt and conditioning information.

### Step 8

Server executes inference of the generative AI model to obtain prediction information.

Server performs forward propagation through the neural network layers of the generative AI model, including embedding layers, attention layers, and feed-forward layers, to compute output token probabilities.

Server decodes the output probabilities into an output text sequence using a decoding strategy such as greedy decoding or beam search.

Server obtains a text output from the generative AI model that contains predicted traits and impressions in the format instructed by the prompt sentence, for example: “traits: optimistic; impressions: cheerful”.

Input: Encoded input tensors corresponding to the prompt sentence and feature quantities.

Output: Generated output text containing prediction information regarding user characteristics and impressions.

### Step 9

Server parses and structures the prediction information.

Server analyzes the generated output text using string parsing rules that search for labels such as “traits:” and “impressions:”.

Server splits the parsed portions into individual labels, trims whitespace, and normalizes label spellings.

Server maps each extracted label to a defined category in a classification scheme stored in the storage device, for example converting “very positive” into a canonical “cheerful” category.

Server stores the resulting characteristic categories and impression categories as structured records associated with the interaction_id and user_id.

Input: Generated output text from the generative AI model.

Output: Structured prediction information consisting of characteristic categories and impression categories.

### Step 10

Server converts the structured prediction information into visual parameters.

Server consults a mapping table that associates characteristic categories and impression categories with visual attributes, such as color codes, icon identifiers, and layout templates.

Server selects color attributes (for example, bright warm colors for optimistic), shape attributes (for example, rounded shapes or specific icons), and layout attributes (for example, positions and sizes of elements) corresponding to the predicted categories.

Server creates a visual parameter object that includes these attributes in a machine-readable format, such as a set of key-value pairs specifying visual properties.

Input: Structured prediction information (characteristic and impression categories).

Output: Visual parameter object containing color attributes, shape attributes, and layout attributes.

### Step 11

Server generates graphic or image information based on the visual parameters.

Server initializes a drawing surface or image buffer with a base color specified by the visual parameters.

Server draws graphical elements, such as shapes, icons, and text labels, at positions defined by the layout attributes, using the color attributes and shape attributes as style settings.

Server may render an avatar, a chart, or a symbolic graphic that visually represents the user's traits and impressions.

Server encodes the resulting graphic or image into a standard image format, such as a raster or vector format, and stores it temporarily in the storage device or memory.

Input: Visual parameter object with color, shape, and layout attributes.

Output: Encoded graphic or image data representing the user's characteristics and impressions.

### Step 12

Server transmits the generated visual information to the terminal.

Server prepares a response message that includes either the image data itself or a reference identifier or path from which the terminal can retrieve the image.

Server sends the response through the communication interface over the network back to the terminal, using a suitable protocol.

Input: Encoded graphic or image data and associated reference metadata.

Output: Network response message containing or referencing the generated visual information.

### Step 13

Terminal receives and displays the visual information for the user.

Terminal accepts the network response from the server and extracts the image data or the reference to the image.

Terminal, when a reference is provided, requests and downloads the image from the specified location.

Terminal decodes the image data and renders it on the display unit, placing the visual elements in a predefined area of the user interface.

Terminal may also display text indicating the predicted traits and impressions, such as “Traits: optimistic; Impressions: cheerful,” adjacent to the visual.

Input: Network response containing or referencing graphic or image data and optional textual prediction results.

Output: Visual presentation on the terminal's display surface, perceivable by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue analysis and personalization systems typically process user messages in isolated pipelines for speech recognition, sentiment analysis, user modeling, and content generation. In many implementations, each component is loosely coupled through ad-hoc interfaces, and prompt sentences for generative AI models are constructed in a static or heuristic manner that does not fully exploit rich contextual signals such as multi-turn dialogue context, emotion dynamics, or previously inferred user traits. As a result, these systems often suffer from several technical problems: high latency due to redundant data transfers between heterogeneous services, inconsistent or unstable prediction of user characteristics, poor alignment between predicted traits and generated visual or textual outputs, and inefficient utilization of computing resources when rendering complex visual information on heterogeneous user terminals.

In particular, existing architectures generally do not provide an integrated mechanism by which a processor (i) derives structured feature values from raw dialogue information, (ii) predicts user characteristic and impression information via a trained estimation model, (iii) automatically composes prompt sentences that are jointly conditioned on dialogue, emotion, and trait information, and (iv) uses those prompt sentences to drive both language-type and image-type generative models in a coordinated way. Without such integrated control, the overall system accuracy and responsiveness degrade, for example because generative AI models receive under-specified or noisy prompts that ignore fine-grained emotional states and context, and because adaptation of visual information to terminal-specific display characteristics is performed in a separate layer with limited access to semantic information.

Furthermore, conventional display pipelines on user terminals often treat generated visual information as static assets. These pipelines usually do not dynamically adjust layout, resolution, or color tone of the generated visual information in response to both terminal display characteristics and real-time usage state. This can lead to suboptimal rendering performance, unnecessary bandwidth consumption, and degraded user experience, particularly on constrained or wearable devices that require low-latency, context-aware rendering.

Accordingly, there is a need for a technical framework that improves the functioning of computer systems by tightly integrating dialogue acquisition, multimodal feature extraction, estimation of characteristic and impression information, prompt sentence generation for generative AI models, and real-time, device-aware rendering. Such a framework should reduce processing redundancy, improve the precision and stability of personality and impression predictions, enhance the relevance and expressiveness of generated guidance and visual information, and optimize the way this information is presented on heterogeneous user terminals.

The specific processing by the specific processing unit 290 of the data processing device 12 in Application Example 2 is realized by the following means.

The present invention provides a server comprising a processor configured to acquire dialogue information from a communication processing apparatus; convert audio information included in the acquired dialogue information into character information by performing speech recognition processing; execute natural language processing on the acquired dialogue information or the character information to extract emotion information and context information; predict and generate characteristic information and impression information of a subject by using a trained estimation model configured to estimate the characteristic information and the impression information based on feature values including the extracted emotion information and the context information; generate a first prompt sentence for input to a generative information processing model, the first prompt sentence being generated based on at least a part of the dialogue information, the emotion information, the characteristic information, and the impression information; input the first prompt sentence to the generative information processing model to generate guidance information or recommendation information; generate visual description information defining content of a visual representation based on the characteristic information and the impression information; generate a second prompt sentence for input to an image generative information processing model based on the visual description information; input the second prompt sentence to the image generative information processing model to generate visual information; generate presentation information including at least part of the guidance information, the recommendation information, and the visual information; and transmit the presentation information to a user terminal for presentation through a display control program that dynamically converts a layout, a resolution, and a color tone of the visual information in accordance with display characteristics of a display device and a usage state of the user terminal. This enables an integrated, computer-implemented processing pipeline that reduces redundant data transformations and inter-component latency, improves the accuracy and consistency of inferred user characteristic and impression information by jointly leveraging dialogue, emotion, and context features, automatically produces prompt sentences that more precisely condition generative AI models, and optimizes real-time rendering of the generated visual and textual outputs on heterogeneous user terminals, thereby enhancing overall system performance and user experience.

The term “dialogue information” refers to digital information representing one or more utterances or messages exchanged via a communication processing apparatus, and may include audio data, text data, metadata, or any combination thereof.

The term “communication processing apparatus” refers to an information processing apparatus that executes communication software or services for sending and receiving messages between users, and may include a server apparatus, a terminal apparatus, or a combination of such apparatuses.

The term “audio information” refers to time-series data representing sound, including a user's speech captured by a sound input device, and may be stored or transmitted in uncompressed or compressed formats.

The term “character information” refers to symbol data representing linguistic content, including letters, numerals, punctuation, and other textual symbols that are obtained by converting audio information or directly input by a user.

The term “speech recognition processing” refers to a computational process that converts audio information representing speech into corresponding character information, using acoustic modeling, language modeling, or other pattern recognition techniques.

The term “natural language processing” refers to a set of computational techniques that analyze or transform human language data, including but not limited to tokenization, morphological analysis, syntactic analysis, semantic analysis, sentiment analysis, and entity extraction.

The term “emotion information” refers to information indicating an estimated emotional state associated with dialogue information, and may include emotion categories such as joy, anger, sadness, or stress, and one or more numeric scores representing intensity or polarity.

The term “context information” refers to information indicating contextual characteristics of dialogue information, including at least one of dialogue history, topic, speaker identity, timing, or surrounding environment information.

The term “feature values” refers to numerical or symbolic values representing properties extracted from dialogue information, emotion information, context information, or related data, and used as input to an estimation model.

The term “characteristic information” refers to information indicating estimated traits of a subject, including personality tendencies, behavioral tendencies, preferences, or similar long-term or mid-term attributes.

The term “impression information” refers to information indicating an estimated impression that the subject gives to others, including perceived attitudes, mood tendencies, or other evaluative descriptors inferred from dialogue information and related features.

The term “subject” refers to an entity, typically a user, whose characteristic information and impression information are estimated based on dialogue information and related data.

The term “trained estimation model” refers to a machine-learned model that has been trained on training data to output characteristic information or impression information from input feature values, and may be implemented using statistical methods, neural networks, or other learning algorithms.

The term “prompt sentence” refers to text information formatted as an instruction or query for a generative information processing model, and constructed so as to cause the model to perform a specific generation task conditioned on given input information.

The term “generative information processing model” refers to a machine-learned model configured to generate text, control information, or other data in response to input information such as a prompt sentence, and may include a generative language model.

The term “guidance information” refers to information that instructs or assists a user or another entity in performing an action, including suggestions for communication, behavior, or system operation derived from outputs of a generative information processing model.

The term “recommendation information” refers to information indicating one or more items, services, or contents selected or prioritized for a subject based on characteristic information, impression information, emotion information, or other criteria.

The term “visual description information” refers to structured information defining content and style of a visual representation, including elements such as objects, scenes, colors, composition, or atmosphere to be depicted.

The term “image generative information processing model” refers to a machine-learned model configured to generate image data or other visual information in response to input information such as a prompt sentence or visual description information.

The term “visual information” refers to data representing one or more visual representations, including still images, graphics, or visual layouts generated or processed by the system.

The term “presentation information” refers to aggregated information prepared for output to a user terminal, and including at least part of guidance information, recommendation information, visual information, or associated control data.

The term “user terminal” refers to an information processing apparatus operated by or for a user, and provided with at least a display device and a communication function for interacting with a server.

The term “display device” refers to a hardware component capable of visually presenting information to a user, including but not limited to flat-panel displays, head-mounted displays, or projection displays.

The term “display control program” refers to software that controls rendering or arrangement of visual information on a display device of a user terminal, based on presentation information received from a server.

The term “auxiliary information” refers to additional information obtained from an external information source by using a prompt sentence or other query, and used to supplement dialogue information, emotion information, characteristic information, or impression information in an estimation process.

The term “external information source” refers to an information providing apparatus or service, separate from a main server, that supplies auxiliary information in response to queries or requests.

The term “learning processing unit” refers to a functional component, implemented in hardware or software, that performs machine learning operations including training, fine-tuning, or updating of estimation models or related parameters.

The term “image processing engine” refers to a functional module that performs image-related operations, including layout adjustment, scaling, color conversion, compositing, or rendering of visual information for display.

The term “display characteristics” refers to properties of a display device, including at least one of resolution, size, aspect ratio, color gamut, brightness, refresh rate, or field of view.

The term “usage state of the user terminal” refers to operational conditions of the user terminal at a given time, including at least one of active application state, orientation, power state, available bandwidth, interaction mode, or user focus.

In one embodiment, a server, a plurality of terminals, and one or more users cooperate to implement the claimed system. The server includes at least one processor, a main memory, a non-volatile storage device, and a network interface connected via a system bus. The terminal includes at least a processor, a memory, an audio input device such as a microphone, a display device such as a flat-panel display or head-mounted display, and a communication interface. The user operates the terminal and provides dialogue information through a communication processing apparatus such as a messaging application, a voice call application, or a mixed audio/text communication platform.

The server executes a group of software modules stored in the storage device and loaded into the main memory. The software modules include a communication module, a speech recognition interface module, a natural language processing module, an emotion analysis module, a feature extraction module, a trained estimation model module, a prompt generation module, a generative AI interface module, an image processing engine, a presentation generation module, a display control interface, and a logging and learning module. The server implements these modules as separate components or as microservices that exchange data via defined data structures.

The server uses a speech recognition interface module to call a generic cloud-based speech recognition service that is functionally similar to a commercial speech-to-text API. The server sends audio information captured by the terminal to the speech recognition service and receives character information as a sequence of tokens with associated confidence scores and time stamps. The server stores the character information in a structured text field of a dialogue record and discards or compresses the original raw audio depending on storage policy. The server converts the received character information into a normalized internal format, for example, a sequence of Unicode code points with segmentation markers.

The server uses a natural language processing module implemented with a general-purpose library such as a tokenization and part-of-speech tagging library, for example, a library similar to NLTK or spaCy. The server applies tokenization, lemmatization, and syntactic dependency parsing to the character information. The server encodes the tokens into integer indices according to a vocabulary table and constructs a sequence representation suitable for neural processing. The server generates feature values, including token embeddings, part-of-speech tags, sentence boundaries, and dialogue turn identifiers.

The server uses an emotion analysis module to derive emotion information. In one variant, the server uses a rule-based sentiment scoring algorithm that combines word-level sentiment scores with part-of-speech weights and negation detection. In another variant, the server uses a supervised classification model implemented as a feedforward neural network, trained to output probabilities for emotion categories such as joy, anger, sadness, stress, and calmness. The server represents the emotion information as a fixed-length vector, where each dimension corresponds to an emotion category, and the value represents an intensity score in a specified range, for example, 0.0 to 1.0.

The server uses a feature extraction module to integrate context information with the emotion information and the token sequence. The server constructs a context vector that includes dialogue history length, recency of messages, terminal type, and interaction mode. The server concatenates the emotion vector, the context vector, and averaged token embeddings to produce a composite feature vector. The server uses this composite feature vector as input to the trained estimation model.

The server implements the trained estimation model as a neural network trained using a framework similar to TensorFlow. In one embodiment, the server uses a transformer-based architecture. The server maps the token sequence to contextual embeddings through multiple self-attention layers, then aggregates these embeddings via mean pooling or attention pooling. The server concatenates the aggregated embedding with the emotion vector and the context vector, then passes the result through multiple fully connected layers with non-linear activation functions such as rectified linear units. The final layer outputs characteristic information and impression information as probability distributions over a set of predefined trait labels. The server trains this model using supervised learning, where ground-truth trait labels and impression labels are provided for training dialogues. The server minimizes a cross-entropy loss between predicted label distributions and ground-truth label distributions. During training, the server updates network weights using a gradient-based optimizer such as stochastic gradient descent with momentum or an adaptive variant.

The server uses data augmentation techniques during training to improve robustness and to enhance technical performance. The server perturbs training texts using synonym replacement, random deletion of low-importance tokens, and shuffling of neutral sentences within a small window, while keeping label assignments. The server thus enables the estimation model to better generalize to noisy or paraphrased inputs. This leads to reduced error rates in trait prediction compared with a model trained solely on exact training sentences.

The server differs from a human operator in that the server applies fixed, non-intuitive combination rules when integrating emotion information and context information into the feature vector. The server assigns different weights to emotion dimensions depending on dialogue length and recency, and the server uses non-linear transformation layers to discover interaction effects that are not easily captured by manual heuristics. This non-conventional feature construction enables the estimation model to respond sensitively to changes in emotion dynamics over time, which in turn yields improved stability and temporal consistency in the predicted characteristic information and impression information.

The server stores predicted characteristic information and impression information in a dedicated data structure in the storage device. In one embodiment, the server uses a relational database table with columns for user identifier, timestamp, trait vector, impression vector, and model version. The server compresses trait and impression vectors into reduced-dimensional codes, for example, by applying principal component analysis offline and storing only the first components. This arrangement reduces storage and transmission overhead when the server needs to send trait summaries to downstream modules.

The server uses a prompt generation module to construct a prompt sentence for a generative AI model. The server does not simply concatenate original text and labels; the server uses a pattern-based and rule-based template system in combination with a smaller language generation model. The server first selects a template according to a scenario type, for example, in-store assistance, self-reflection, or content recommendation. The server then fills template slots with summarized dialogue text, emotion information, characteristic information, and impression information. The server may also add control markers such as explicit style instructions, length constraints, and output format hints.

In one concrete example for language guidance, the server generates a prompt sentence such as:

“Given the customer's conversation: ‘Recently, work has been so busy and I feel really stressed.’ and the inferred impression: ‘stressed, needing relaxation’, suggest how a store clerk should respond and which product categories to propose.”

In another example for personality analysis and explanation, the server generates a prompt sentence such as:

“Analyze the following user chat history and infer personality traits and current emotions. Chat history: ‘I love trying new things. Next month I want to go on an adventure trip.’ Generate a short textual summary of the personality and a product recommendation.”

The server uses a generative AI interface module to transmit these prompt sentences to an external generative AI model, which may be a large-scale generative language model that accepts prompt sentences and returns generated text. The server specifies decoding parameters such as maximum token count, temperature, and top-p sampling values. The server receives the generated guidance information or recommendation information, parses the returned text, and stores it as part of the presentation information.

The server also uses the prompt generation module to produce prompt sentences for an image generative information processing model. The server converts characteristic information and impression information into visual description information by applying mapping rules. For example, the server associates an “optimistic” trait with bright color palettes, high saturation, and upward-oriented compositions; the server associates a “stressed” state with subdued colors and a crowded composition; and the server associates a “relaxed” state with soft, low-saturation colors and natural scenes. The server encodes these associations into a structured internal representation and then serializes that representation into a natural-language prompt sentence for an image generative model.

In one example, the server generates a prompt sentence such as:

“Generate an image that expresses an optimistic and adventurous personality using bright, vibrant colors and a dynamic scene with mountains and a wide sky.”

In another example for mood visualization, the server generates a prompt sentence such as:

“Generate a calm, nature-themed image that reflects a relaxed user, with soft green tones and a quiet forest at sunset.”

In a content recommendation scenario, the server generates a prompt sentence such as:

“Based on the sentiment score 0.8 (very positive), generate an image suitable for a ‘Bright and cheerful playlist’cover.”

The server uses the generative AI interface module to send these prompt sentences to an image generative information processing model that may implement a diffusion-based or autoregressive architecture. The server receives visual information as image files or image data, and then processes the visual information with the image processing engine. The server adjusts layout, resolution, and color tone based on display characteristics of the user terminal. The server reads terminal capabilities such as pixel resolution, color depth, and orientation, and modifies the visual information accordingly. For example, the server crops panoramic images for vertical displays or scales them down for head-mounted displays with limited resolution.

The server uses the presentation generation module to assemble guidance information, recommendation information, and visual information into presentation information. The server encapsulates this information in a structured data format, such as a record including fields for textual guidance, product identifiers, image references, and display layout hints. The server transmits the presentation information to the terminal via the network interface using a transport protocol.

The terminal receives the presentation information and uses a display control program to render the visual information and text on the display device. In one embodiment, the terminal implements the display control program as a web-based client using a markup language and a scripting language. In another embodiment, the terminal implements the display control program as a native application for a head-mounted display. The terminal reads layout hints from the presentation information and positions guidance information and visual information on the screen in non-overlapping regions, or overlays them semi-transparently on top of existing application views.

The terminal may dynamically adjust the display based on the usage state of the terminal. For instance, when the terminal detects that the user is actively typing in a messaging application, the terminal presents only a concise text summary in a narrow banner. When the terminal detects an idle state, the terminal displays a larger visual representation or a full-screen mood image. The terminal thus reduces user distraction and optimizes information density according to real-time context.

The user views the presented visual information and guidance information and may adapt behavior or make selections accordingly. In an in-store assistance scenario, the user acting as a store clerk reads a short suggestion such as “Customer is stressed. Suggest relaxation goods such as aroma diffusers and herbal tea.” and uses this suggestion to guide conversation. In a self-reflection scenario, the user views a generated personality or mood image and a textual summary such as “You appear optimistic and adventurous recently” and can recognize changes in mood or traits over time.

The server logs all intermediate data, including feature vectors, predicted traits, prompt sentences, generated outputs, and user interactions. The server uses the logging and learning module to periodically retrain or fine-tune the trained estimation model using new data. The server computes a new loss function that combines prediction accuracy for characteristic information and impression information, temporal stability of predictions across sessions, and correlation with user feedback, where available. The server updates model parameters accordingly. The server also refines prompt generation rules based on downstream performance, for example, by learning that certain combinations of trait descriptors and style descriptors lead to higher user engagement or lower error rates in generative outputs.

This architecture improves computer technology in several ways. The server reduces processing latency and network load by integrating speech recognition interface, natural language processing, feature extraction, estimation, prompt generation, and rendering control within a coordinated pipeline that uses shared internal data structures. The server avoids repeated serialization and deserialization of large text and image payloads across loosely coupled services. The composite feature vector that explicitly combines emotion information, context information, and semantic embeddings improves prediction accuracy for characteristic and impression information, compared with systems that rely only on raw text. The prompt generation module generates richer and more precise prompt sentences that encode multiple dimensions of user state, resulting in generative AI outputs that are more aligned with intended guidance and visual representation, thereby reducing the need for post-processing or manual correction.

The image processing engine and display control mechanisms optimize technical resource usage on heterogeneous terminals. By adapting image resolution and layout to display characteristics and usage state, the system reduces unnecessary data transfer of overly high-resolution images and reduces rendering workload on constrained devices, leading to lower power consumption and improved responsiveness. The described training strategy with feature-level integration, non-linear modeling, and data augmentation is not a mere automation of human judgment. A human typically cannot compute and maintain consistent multi-dimensional trait vectors across thousands of dialogue turns, nor can a human dynamically generate standardized prompt sentences that incorporate fine-grained emotion dynamics, context vectors, and device capabilities. The server performs these operations using specific neural network architectures, defined loss functions, and weight update rules that operate at machine scale and speed.

In alternative embodiments, the server may employ different neural architectures for the trained estimation model, such as a bidirectional recurrent network, a convolutional network on character sequences, or a hybrid transformer-recurrent model, provided that the model consumes feature values derived from dialogue information, emotion information, and context information and outputs characteristic information and impression information. The server may also use different generative AI models for language and image generation, including smaller domain-specific models deployed on-premises. The terminal may be implemented as a smartphone, a tablet, a desktop computer, a head-mounted wearable, or an in-vehicle display system. The system may be applied in use cases such as adaptive user interfaces, mental health monitoring dashboards, educational content personalization, or automotive in-cabin assistance, provided that the core mechanism of integrated estimation, prompt sentence generation, generative AI usage, and device-aware rendering is maintained.

Through these embodiments, the server, the terminal, and the user cooperate in a way that is tightly coupled to the physical characteristics and computational constraints of real devices, and the described system improves fundamental aspects of computer-based dialogue processing, generative AI conditioning, and multi-device visualization beyond mere automation of manual processes.

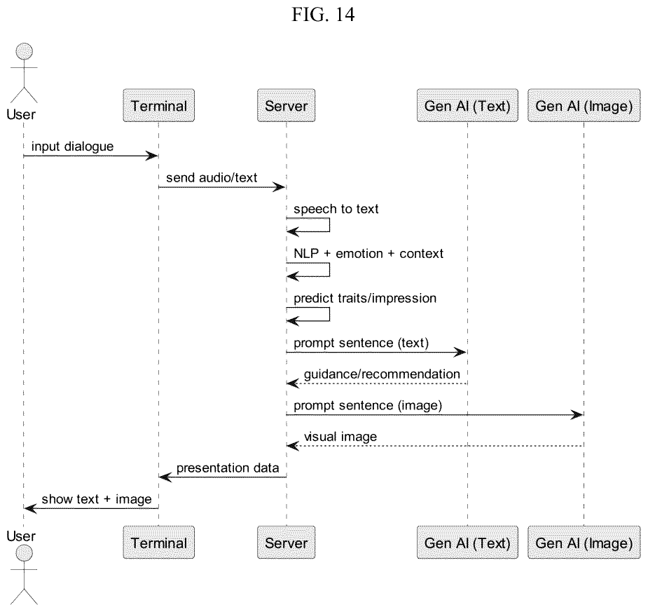

The following describes the processing flow using FIG. 14.

### Step 1

User provides dialogue information to the system.

User inputs text messages into a communication application on the terminal or speaks near a microphone of the terminal. As input, the system receives raw audio waveforms or text strings such as “Recently, work has been so busy and I feel really stressed.” As output, the terminal holds this dialogue information in a temporary buffer or application data structure for further transmission.

### Step 2

Terminal acquires and packages dialogue information.

Terminal captures audio data from the microphone and samples it at a predetermined rate, for example 16 kHz, encoding the samples into a digital audio format such as PCM or a compressed format. Terminal also acquires text messages directly from the communication application. As input, the terminal uses the raw signal from the microphone and application text events; as output, the terminal generates a structured message object that includes an audio field or a text field, a user identifier, a timestamp, and a session identifier.

### Step 3

Terminal transmits dialogue information to the server.

Terminal opens a secure communication channel, for example an HTTPS or WebSocket connection, to the server and sends the structured message object. As input, the terminal uses the message object created in Step 2; as output, the terminal produces a network packet stream that encapsulates the dialogue information and delivers it to the server's communication endpoint.

### Step 4

Server receives and stores raw dialogue information.

Server accepts incoming packets through a network interface and reconstructs the structured message object. Server validates message integrity and stores the message object in a dialogue cache and optionally in a persistent storage table. As input, the server uses the received network packet stream; as output, the server produces a normalized dialogue record that includes fields for audio data, text data (which may be empty at this stage), metadata, and processing status.

### Step 5

Server performs speech recognition on audio information.

Server checks whether the dialogue record includes audio data without corresponding text. If so, server invokes a speech recognition module and sends the audio data to a speech recognition engine. The engine applies acoustic modeling and language modeling to transform audio waveforms into a sequence of linguistic tokens. As input, the server uses the audio field of the dialogue record; as output, the server obtains character information, for example a Unicode text string and optional word-level timestamps, and inserts this text into the dialogue record.

### Step 6

Server normalizes character information.

Server converts the character information into a standardized internal representation. Server applies operations such as Unicode normalization, removal of control characters, and insertion of sentence boundary markers. As input, the server uses the raw transcription string; as output, the server produces a cleaned text sequence and stores it in a text field, updating the processing status of the dialogue record to indicate that text is available.

### Step 7

Server applies natural language preprocessing.

Server invokes a natural language processing module to process the cleaned text. Server tokenizes the text into words, assigns part-of-speech tags, and performs lemmatization. As input, the server uses the normalized text sequence; as output, the server generates a token sequence, a part-of-speech sequence, and a lemma sequence, which it stores in a feature data structure associated with the dialogue record.

### Step 8

Server computes emotion information.

Server processes the token sequence and lemma sequence to derive emotion information. In one embodiment, server passes the text to an emotion classifier that computes scores for emotion categories such as joy, anger, sadness, stress, and calmness. The classifier performs a data operation that maps high-dimensional text embeddings to a lower-dimensional emotion vector through a neural network. As input, the server uses the preprocessed text and features; as output, the server produces an emotion vector and an overall sentiment score, and writes them into the dialogue record.

### Step 9

Server constructs context information.

Server collects contextual features for the current dialogue. Server counts the number of dialogue turns within a recent time window, determines the elapsed time since the previous message, reads the terminal type, and checks whether the user is in a particular usage scenario. As input, the server uses metadata from the dialogue record and conversation history; as output, the server generates a context vector encoding dialogue length, recency, device type, and scenario identifiers, and attaches this context vector to the feature data structure.

### Step 10

Server builds a composite feature vector.

Server integrates linguistic features, emotion information, and context information into a single composite feature vector. Server averages or pools token embeddings, concatenates the pooled embedding with the emotion vector and the context vector, and optionally scales or normalizes each component. As input, the server uses token-level embeddings, the emotion vector, and the context vector; as output, the server obtains a fixed-length numeric vector suitable for input to an estimation model and records this vector in a model input field.

### Step 11

Server predicts characteristic information and impression information.

Server passes the composite feature vector into a trained estimation model that has been implemented, for example, as a transformer-based neural network followed by fully connected layers. The model performs matrix multiplications, non-linear activation functions, and normalization to compute probabilities over predefined traits and impressions. As input, the server uses the composite feature vector; as output, the server generates characteristic information and impression information, such as probability distributions over labels like “optimistic”, “adventurous”, “stressed”, or “cooperative”, and stores these outputs in a trait record associated with the user.

### Step 12

Server updates user trait history.

Server retrieves the previous trait record for the user and combines it with the newly predicted trait and impression information. Server may apply an exponential moving average to smooth fluctuations over time. As input, the server uses the newly predicted traits and historical trait vectors; as output, the server writes an updated trait vector and impression vector back to the user profile table, thereby maintaining a temporal summary of user characteristics.

### Step 13

Server generates a language-oriented prompt sentence.

Server activates a prompt generation module and selects a template according to the use case, for example in-store assistance or content recommendation. Server fills template slots with the latest dialogue text, emotion labels, and trait labels. Server may also shorten the dialogue text by summarizing its content with a heuristic rule or a lightweight summarization model. As input, the server uses the cleaned text, the emotion vector, and the updated trait information; as output, the server produces a language-oriented prompt sentence designed for a generative AI model.

### Step 14

Server sends the language-oriented prompt sentence to a generative AI model.

Server delivers the prompt sentence to an external or internal generative language model via an API. Server encodes the prompt sentence into a request payload and specifies generation parameters such as maximum output length and randomness levels. As input, the server uses the prompt sentence from Step 13; as output, the server receives generated text that includes guidance information or recommendation information, for example a suggested reply or a set of product categories.

### Step 15

Server parses and structures guidance information or recommendation information.

Server analyzes the generated text to extract actionable components. Server may identify recommended categories, suggested phrases, or explicit action items by applying pattern matching or additional lightweight semantic parsing. As input, the server uses the generated text from the generative AI model; as output, the server creates a structured guidance record containing fields such as recommended action, target item types, and suggested wording.

### Step 16

Server constructs visual description information.

Server converts characteristic information and impression information into visual description information by mapping specific traits to visual elements. Server applies rule-based mappings, for example associating “optimistic” with bright colors, “adventurous” with dynamic landscapes, and “stressed” with tension-related compositions. As input, the server uses the trait vector and impression vector; as output, the server generates a structured list of visual attributes such as color scheme, scene type, and composition style.

### Step 17

Server generates an image-oriented prompt sentence.

Server serializes the visual description information into a natural language sentence suitable for an image generative AI model. Server may also include emotion intensity and contextual hints in the description. As input, the server uses the visual attributes produced in Step 16; as output, the server produces an image-oriented prompt sentence such as “Generate a calm, nature-themed image that reflects a relaxed user, with soft green tones and a quiet forest at sunset.”

### Step 18

Server sends the image-oriented prompt sentence to an image generative AI model.

Server invokes an image generation API and sends the image-oriented prompt sentence along with parameters such as resolution and aspect ratio. The generative AI model performs iterative sampling operations to produce image data conditioned on the prompt. As input, the server uses the prompt sentence from Step 17; as output, the server receives image data, for example in a raster format, and stores it as visual information in an image repository.

### Step 19

Server post-processes visual information.

Server applies an image processing engine to adjust the visual information to match terminal capabilities and contextual requirements. Server may crop, resize, or recolor the image, and may overlay text or icons if necessary. As input, the server uses the raw generated image data and display characteristics of the target terminal; as output, the server produces a processed image that is optimized for the terminal's resolution, color space, and layout constraints.

### Step 20

Server composes presentation information.

Server combines structured guidance information or recommendation information with processed visual information into a unified presentation object. Server includes layout hints, priority indicators, and validity periods. As input, the server uses the guidance record from Step 15 and the processed image from Step 19; as output, the server generates a presentation record containing all data required for display on the terminal.

### Step 21

Server transmits presentation information to the terminal.

Server sends the presentation record to the terminal using a communication protocol. Server may serialize the record into a compact format and schedule transmission according to network congestion conditions. As input, the server uses the presentation record from Step 20; as output, the server produces network packets that carry textual and visual payloads to the terminal.

### Step 22

Terminal receives and interprets presentation information.

Terminal reads the incoming packets and reconstructs the presentation record. Terminal parses layout hints, textual content, and visual references. As input, the terminal uses the packet stream from the server; as output, the terminal constructs internal objects that represent the guidance text, recommendation details, and image resources.

### Step 23

Terminal renders guidance information and visual information.

Terminal invokes a display control program that decides how to place the visual information and text within the available display area. Terminal retrieves the image data, decodes it into a bitmap, and draws it onto the screen, then overlays or positions the guidance text alongside the image. As input, the terminal uses the presentation objects assembled in Step 22; as output, the terminal produces a rendered frame on the display device that visually presents guidance information and visual information to the user.

### Step 24

User views and reacts to the presented information.

User looks at the display on the terminal, reads the guidance text, and sees the generated image or visual representation. Based on this output, the user may perform an action such as modifying communication style, selecting recommended content, or adjusting behavior. As input, the user receives the visual and textual outputs from the terminal; as output, the user produces new dialogue information, feedback, or operational choices, which can be captured again by the terminal and processed in subsequent cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

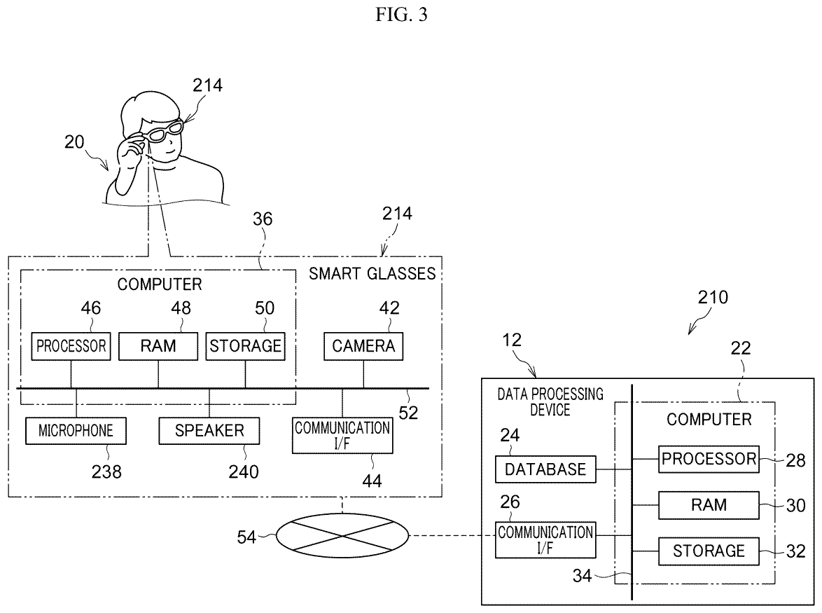

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

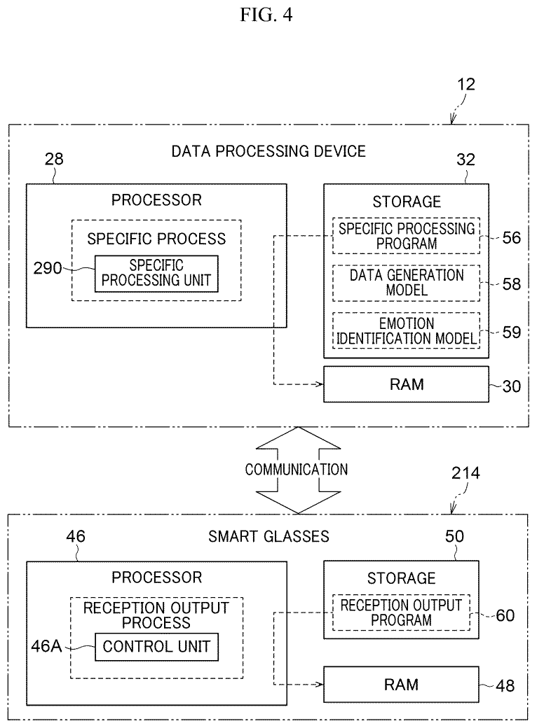

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

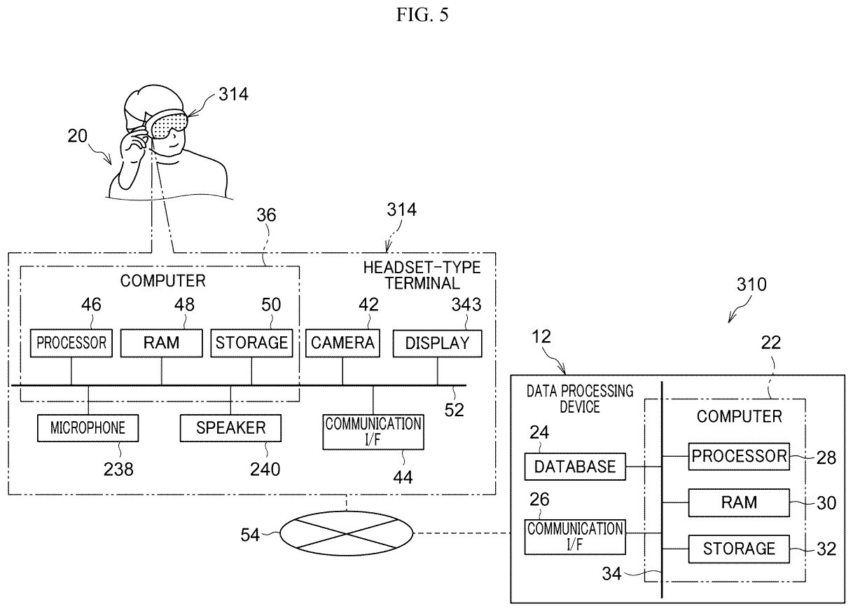

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

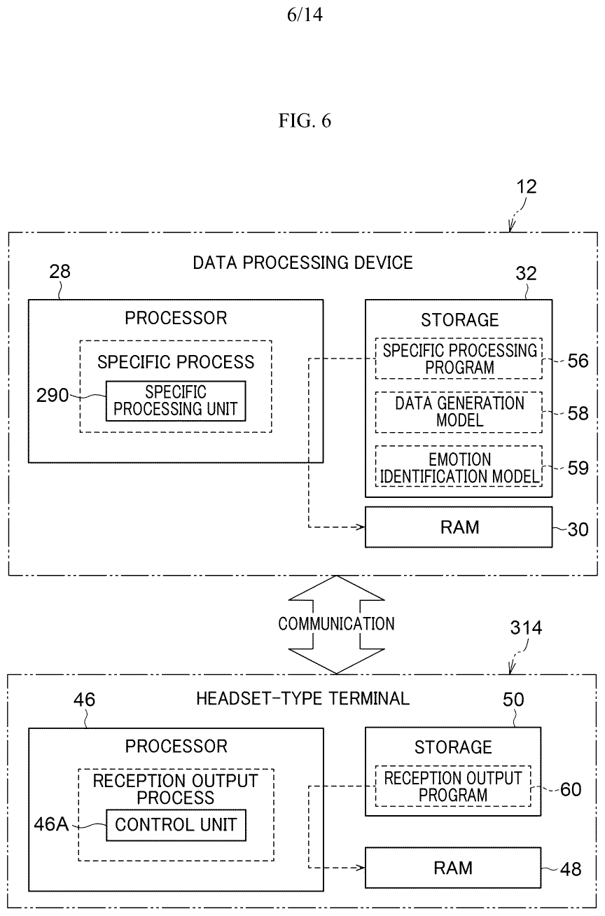

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

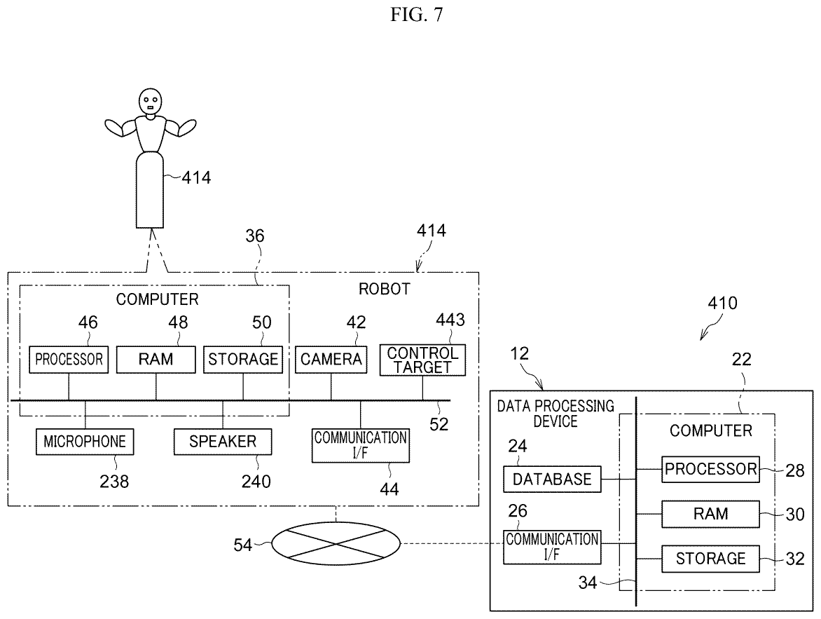

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

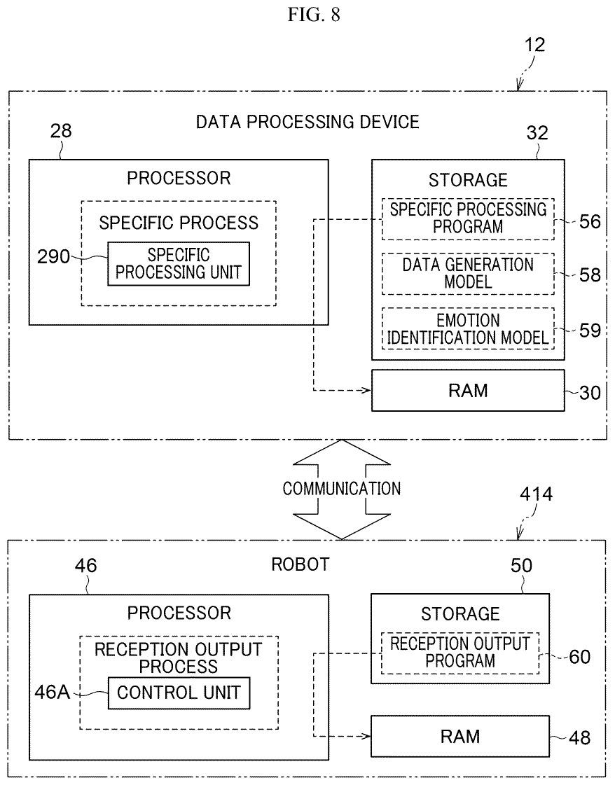

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

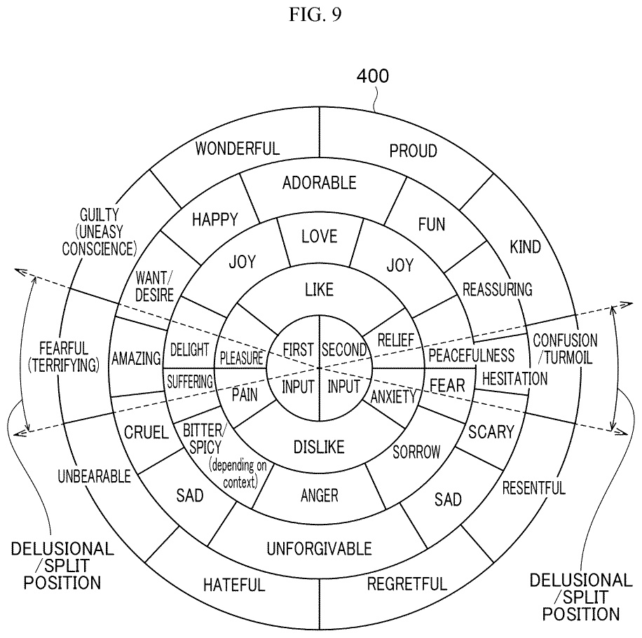

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

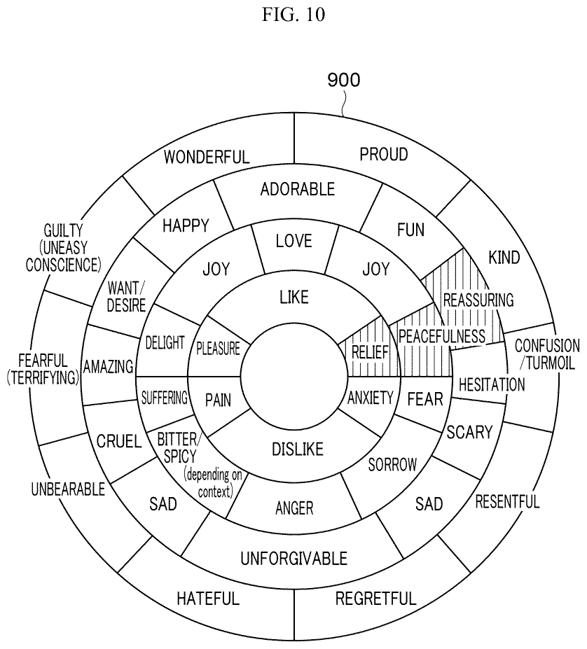

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
acquire dialog data from a communication application executed on a terminal operated by a user,
store the acquired dialog data in the storage device together with associated information including at least a user identifier and time information,
aggregate dialog data stored in the storage device for a particular user and generate a prompt sentence to be input to a generative AI model based on the aggregated dialog data,
input the generated prompt sentence to the generative AI model and obtain prediction information relating to characteristics and impressions of the user corresponding to the dialog data,
convert the obtained prediction information into numerical information or structured information and generate visual information representing personality characteristics of the user on the basis of the numerical information or the structured information, and
transmit the generated visual information via a communication network in response to a request from the terminal or in accordance with a predetermined condition, and present the visual information in a displayable format on the terminal.

### Supplementary 2

The system according to supplementary 1,
wherein the processor is configured to control the generated prompt sentence such that the generated prompt sentence is formed by inserting at least a part of the dialog data into a predetermined template and includes content that instructs the generative AI model to output at least summary information on the user's characteristics and impressions, emotional tendency information, and evaluation information for each of a plurality of personality dimensions.

### Supplementary 3

The system according to supplementary 1,
wherein the processor is configured to generate the visual information as information that represents evaluation results for each of a plurality of personality dimensions in a plurality of types of graphic formats, by generating graph information or figure information based on the prediction information, and to output display control information for causing the terminal to render a display image based on the graph information or the figure information.

### Application Example 1

### Supplementary 1

A system comprising a processor,
wherein the processor is configured to
acquire interaction information from an information processing apparatus having a communication function,
generate instruction information as a prompt sentence based on the acquired interaction information, input the generated prompt sentence into a generative AI model to predict personality features or impression features of a target individual,
store the interaction information and the personality features or impression features in an accumulation information structure in association with conversation identification information or user identification information,
normalize attribute values representing the personality features or impression features into quantitative indices and generate visual presentation data by selecting a visualization format according to the quantitative indices,
generate image information or screen layout information by using the visual presentation data,
transmit the generated image information or screen layout information via a communication path to a terminal having a display function, the terminal including at least one of a portable terminal device and a wearable display device, and
output display control information to cause the terminal to perform real-time superimposed display or overlay display of the image information or the screen layout information on a display device of the terminal.

### Supplementary 2

The system according to supplementary 1,
wherein the processor is configured to perform, in generating the prompt sentence, processing that acquires a time-series history of the interaction information, aggregates a predetermined number of most recent utterances as conversation context information, incorporates the conversation context information into the prompt sentence, and thereby provides the generative AI model with instruction content including estimation conditions and an output format for the personality features or impression features.

### Supplementary 3

The system according to supplementary 1,
wherein the processor is configured to, in generating the visual presentation data, determine graphic information including hue information, shape information, and arrangement information according to the quantitative indices of the personality features or impression features, generate visual information including graphic elements indicating index values and character elements indicating recommended response contents by using a graphics processing mechanism or a drawing library, and generate output data for causing the visual information to be updated and displayed in real time on the display device of the terminal.

### Example 2

### Supplementary 1

A system comprising a processor,
wherein the processor is configured to
acquire interaction data from an information processing device having a communication function, store the acquired interaction data in a storage device,
perform preprocessing on the stored interaction data, the preprocessing including at least a character removal process, a normalization process, and a segmentation process,
extract feature quantities including occurrence frequency information, evaluation information, and statistical information from the preprocessed interaction data and generate a numerical vector,
generate a prompt sentence, based on information including the numerical vector and the interaction data, for estimating a characteristic and an impression of a user,
input the generated prompt sentence and the feature quantities into a generative information processing model to generate prediction information regarding the characteristic and the impression of the user,
associate the generated prediction information with a predetermined classification scheme to determine a characteristic category and an impression category,
convert the determined characteristic category and impression category into visual parameters including at least a color attribute, a shape attribute, and a layout attribute,
generate graphic information or image information based on the visual parameters, and
transmit the generated graphic information or image information via a communication network to a terminal device having a display function and cause the terminal device to present the generated graphic information or image information on a display surface.

### Supplementary 2

The system according to supplementary 1,
wherein the processor is configured to
include, in the prompt sentence, output format specification information that instructs the generative information processing model to return the characteristic and the impression in a structured data format, and to obtain the prediction information in the structured data format.

### Supplementary 3

The system according to supplementary 1,
wherein the processor is configured to
include, in the visual parameters, an index indicating a temporal change for each user or for each interaction, and to generate, as the graphic information or the image information, visual information that continuously represents a change of the index.

### Application Example 2

### Supplementary 1

A system comprising a processor,
wherein the processor is configured to
acquire dialogue information from a communication processing apparatus,
convert audio information included in the acquired dialogue information into character information by performing speech recognition processing,
execute natural language processing on the acquired dialogue information or the character information to extract emotion information and context information,
predict and generate characteristic information and impression information of a subject by using a trained estimation model configured to estimate the characteristic information and the impression information based on feature values including the extracted emotion information and the context information,
generate a prompt sentence for input to a generative information processing model, the prompt sentence being generated based on at least a part of the dialogue information, the emotion information, the characteristic information, and the impression information,
input the prompt sentence to the generative information processing model to generate guidance information or recommendation information,
generate visual description information defining content of a visual representation based on the characteristic information and the impression information, and generate a prompt sentence for input to an image generative information processing model based on the visual description information,
input the prompt sentence to the image generative information processing model to generate visual information,
generate presentation information including at least part of the guidance information, the recommendation information, and the visual information as configuration information, and transmit the presentation information to a user terminal, and
present the visual information and the guidance information or the recommendation information to a display device of the user terminal through a display control program.

### Supplementary 2

The system according to supplementary 1,
wherein the processor is configured to
acquire auxiliary information from an external information source by using the prompt sentence, and
perform an estimation process by a learning processing unit by combining the auxiliary information with the dialogue information, the emotion information, the characteristic information, and the impression information so as to update or improve accuracy of the characteristic information and the impression information.

### Supplementary 3

The system according to supplementary 1,
wherein the processor is configured to
employ an image processing engine that dynamically converts a layout, a resolution, and a color tone of the visual information in accordance with display characteristics of the display device and a usage state of the user terminal, and performs real-time rendering to superimpose the visual information on a display area of the user terminal.

What is claimed is:

1. A system comprising:
circuitry configured to
receive, via a packet-switched network, a plurality of input data sequences from a software application executed on a remote device,
preprocess the received plurality of input data sequences to generate structured input data,
generate a prompt data sequence based on the structured input data,
input the generated prompt data sequence to a generative neural network model to compute inference output data,
convert the inference output data into rendered output data, and
transmit, via the packet-switched network, the rendered output data to the remote device for presentation on a display of the remote device.

2. The system according to claim 1, wherein the circuitry is further configured to store the received plurality of input data sequences in a storage device together with associated metadata comprising at least an identifier and temporal information.

3. The system according to claim 2, wherein the circuitry is further configured to aggregate, from the storage device, stored input data sequences associated with a particular identifier, and to generate the prompt data sequence based on the aggregated input data sequences.

4. The system according to claim 3, wherein the aggregating comprises selecting input data sequences within a predetermined temporal range, ordering the selected input data sequences chronologically, and filtering the ordered input data sequences based on a minimum data length threshold.

5. The system according to claim 4, wherein the plurality of input data sequences comprise dialog data representing text-based exchanges obtained from a communication application, and wherein the associated metadata further comprises a conversation identifier and a sender identifier.

6. The system according to claim 5, wherein the circuitry is further configured to generate the prompt data sequence by inserting at least a portion of the aggregated dialog data into a predetermined template, the predetermined template comprising an instruction section that specifies output of personality dimension evaluation scores, emotional tendency information, and summary information relating to characteristics and impressions of a user.

7. The system according to claim 6, wherein the generative neural network model comprises a transformer-based architecture comprising a plurality of self-attention layers configured to compute contextual representations of tokens of the prompt data sequence, and wherein the circuitry is further configured to specify model inference parameters comprising at least a maximum output length and a sampling parameter when inputting the prompt data sequence to the generative neural network model.

8. The system according to claim 1, wherein the circuitry is further configured to parse the inference output data to extract a plurality of numerical scores corresponding to respective evaluation dimensions, and to normalize the extracted plurality of numerical scores to a common scale.

9. The system according to claim 8, wherein the circuitry is further configured to store the normalized plurality of numerical scores in the storage device in association with the identifier and a timestamp, thereby enabling retrieval of historical evaluation data for longitudinal comparison.

10. The system according to claim 9, wherein the circuitry is further configured to compute a temporal change index for each evaluation dimension based on a comparison between the normalized plurality of numerical scores and previously stored numerical scores, and to generate the rendered output data to include a visual representation of the temporal change index.

11. The system according to claim 10, wherein the evaluation dimensions comprise a plurality of personality dimensions, and wherein the visual representation comprises a radar chart having axes corresponding to respective personality dimensions with plotted values derived from the normalized plurality of numerical scores.

12. The system according to claim 1, wherein the circuitry is further configured to generate the rendered output data by computing visual parameters comprising at least a color attribute, a shape attribute, and a layout attribute based on the inference output data, and to generate graphic data or image data based on the computed visual parameters.

13. The system according to claim 12, wherein the circuitry is further configured to generate display control information specifying a rendering layout for the rendered output data on the display of the remote device, the display control information comprising at least a display region, an overlay transparency value, and an update timing parameter for real-time superimposed display.

14. The system according to claim 13, wherein the remote device comprises at least one of a portable terminal device and a wearable display device, and wherein the circuitry is further configured to adjust a resolution and a color tone of the rendered output data in accordance with display characteristics of the display of the remote device.

15. The system according to claim 1, wherein the circuitry is further configured to perform preprocessing on the received plurality of input data sequences, the preprocessing comprising at least a character removal process for removing predetermined characters, a normalization process for unifying character representations, and a segmentation process for dividing the input data sequences into linguistic units.

16. The system according to claim 15, wherein the circuitry is further configured to extract feature quantities from the preprocessed input data sequences, the feature quantities comprising occurrence frequency information, evaluation information, and statistical information, and to generate a numerical feature vector from the extracted feature quantities, wherein the prompt data sequence is generated based on information comprising the numerical feature vector and the input data sequences.

17. The system according to claim 16, wherein the circuitry is further configured to execute natural language processing on the preprocessed input data sequences to extract emotion information comprising emotion category scores and context information comprising dialog history length and recency, and to input the emotion information and the context information as additional feature values to a trained estimation model configured to predict characteristic information and impression information of a user.

18. A system comprising:
circuitry configured to
receive, via a packet-switched network, a plurality of input data sequences comprising text-based exchange data from a software application executed on a remote device,
store the received plurality of input data sequences in a storage device together with associated metadata comprising an identifier and temporal information,
aggregate stored input data sequences associated with a particular identifier, filter the aggregated input data sequences based on a temporal range and a minimum data length threshold, and generate a prompt data sequence by inserting at least a portion of the filtered input data sequences into a predetermined template comprising an instruction section and an output format specification,
input the generated prompt data sequence to a generative neural network model comprising a transformer-based architecture to compute inference output data comprising a plurality of evaluation scores corresponding to respective evaluation dimensions,
parse and normalize the inference output data, compute visual parameters comprising a color attribute, a shape attribute, and a layout attribute based on the normalized inference output data, and generate rendered output data comprising graphic data defining a graphical representation of the evaluation scores, and
transmit, via the packet-switched network, the rendered output data together with display control information to the remote device for real-time presentation on a display of the remote device.

19. The system according to claim 18, wherein the circuitry is further configured to generate visual description information based on the inference output data and to generate a second prompt data sequence for input to an image generative neural network model, and to input the second prompt data sequence to the image generative neural network model to generate image data representing a visual representation of predicted characteristics, the rendered output data further comprising the generated image data.

20. A method performed by a system comprising circuitry, the method comprising:
receiving, via a packet-switched network, a plurality of input data sequences from a software application executed on a remote device;
preprocessing the received plurality of input data sequences to generate structured input data;
generating a prompt data sequence based on the structured input data;
inputting the generated prompt data sequence to a generative neural network model to compute inference output data;
converting the inference output data into rendered output data; and
transmitting, via the packet-switched network, the rendered output data to the remote device for presentation on a display of the remote device.
